(19) United States
(12) Patent Application Publication
(10) Pub. No.: US 2024/0249127 A1
(43) Pub. Date: Jul. 25, 2024

(54) NEURAL NETWORK PROCESSING

(71) Applicant: Arm Limited, Cambridge (GB)

(72) Inventors: Thomas James Cooksey, Cambridgeshire (GB); Elliot Maurice Simon Rosemarine, London (GB)

(73) Assignee: Arm Limited, Cambridge (GB)

(21) Appl. No.: 18/349,124

(22) Filed: Jul. 8, 2023

(30) Foreign Application Priority Data
Jan. 20, 2023 (GB) 2300909.5

(51) Int. Cl. G06N 3/063

(52) U.S. Cl. CPC G06N 3/063

(57) ABSTRACT

A data processing system comprising a processor (306) that is configured to perform neural network processing having one or more execution units (213, 214) configured to perform processing operations for neural network processing and a control circuit (217) configured to distribute processing tasks to the execution unit or units, and a graphics processor (304) comprising a programmable execution unit (203) operable to execute processing programs to perform processing operations. The control circuit (217) of the processor (306) that is configured to perform neural network processing is configured to, in response to an indication of particular neural network processing to be performed provided to the control circuit, cause the programmable execution unit (203) of the graphics processor to execute a program to perform the indicated neural network processing.

### BACKGROUND

The technology described herein relates to neural network processing, and in particular to the performing of neural network processing in data processing systems that include a processor that is specifically configured to perform neural network processing, such as a neural processing unit (NPU).

Generally speaking, neural network processing requires various, particular arithmetic operations. For example, when applying a filter to an input data array, the processing may comprise performing weighted sums a “multiply-accumulate” (MAC) operation. Typically the data structures used to represent the data to be used for the neural network processing (e.g. the input data array, the filters, the output data array, etc.) are tensors. The arithmetic operations thus typically comprise tensor arithmetic, e.g. tensor multiplication, addition, and so on.

To facilitate neural network processing, in some data processing systems a dedicated neural network processing hardware accelerator (e.g. neural processing unit, NPU) is provided as a hardware accelerator that is operable to perform such neural network processing as and when desired, e.g. in response to an application that is executing on a host processor (e.g. central processing unit (CPU)) requiring neural network processing.

Such a neural network processing hardware accelerator typically comprises hardware (for example comprising fixed function processing circuits) which is configured for more efficiently performing neural network processing operations of a particular type or types. For example, a neural accelerator may be, and typically is, configured to perform tensor arithmetic operations, such as tensor MAC operations, and may therefore comprise a plurality of fixed-function multiplier-accumulator circuits (“MAC units”) which are arranged to perform such MAC operations on tensor data structures.

A benefit of providing a neural accelerator is therefore that at least these types of arithmetic operations can then be performed in a more optimised manner, e.g. using dedicated fixed-function hardware circuitry, compared to using another processor (e.g. the CPU) to perform the calculations in a general purpose manner. This also then frees-up other components (e.g. the host processor (CPU)) to perform other processing tasks, as desired, which may improve the overall processing efficiency. This can be particularly important for resource constrained devices, such as mobile devices, where the CPU resource may be limited.

In such data processing systems, the, e.g. host processor (CPU) will be operable to request the neural accelerator to perform a set of neural network processing operations, for example for an application executing on the host processor (CPU). A driver for the neural accelerator can then identify and determine the neural network processing to be performed, and indicate to the neural accelerator the appropriate operations, and data, for performing the desired neural network processing.

The Applicants believe that there remains scope for improvements to the performing of neural network processing in data processing systems.

### BRIEF DESCRIPTION OF THE DRAWINGS

A number of embodiments of the technology described herein will now be described by way of example only and with reference to the accompanying drawings, in which:

FIG. 1 shows an exemplary data processing system in which the technology described herein can be implemented;

FIG. 2 shows schematically an integrated graphics processor and neural processor in an embodiment;

FIG. 3 shows schematically software components in an embodiment;

FIG. 4 shows an exemplary neural network;

FIG. 5 shows a descriptor for the neural network of FIG. 4 in an embodiment;

FIGS. 6 and 7 show the generation of descriptors for neural networks in embodiments;

FIGS. 8 and 9 show the operation when performing neural network processing in an embodiment;

FIG. 10 shows the compilation of a shader program in an embodiment; and

FIG. 11 shows an exemplary shared buffer layout in an embodiment.

Like reference numerals are used for like features in the drawings (where appropriate).

### DETAILED DESCRIPTION

A first embodiment of the technology described herein comprises a method of operating a data processing system, the data processing system comprising:
a processor that is configured to perform neural network processing, the processor comprising:
   one or more execution units configured to perform processing operations for neural network processing; and
   a control circuit configured to distribute processing tasks to the execution unit or units to cause the execution units to perform processing operations for neural network processing in response to indications of neural network processing to be performed provided to the control circuit;
the data processing system further comprising a graphics processor, the graphics processor comprising a programmable execution unit operable to execute processing programs to perform processing operations;
the method comprising:
   the control circuit of the processor that is configured to perform neural network processing, in response to an indication of neural network processing to be performed, causing the programmable execution unit of the graphics processor to execute a program to perform the indicated neural network processing.

A second embodiment of the technology described herein comprises a data processing system, the data processing system comprising:
a processor that is configured to perform neural network processing, the processor comprising:
   one or more execution units configured to perform processing operations for neural network processing; and
   a control circuit configured to distribute processing tasks to the execution unit or units to cause the execution units to perform processing operations for neural network processing in response to indications of neural network processing to be performed provided to the control circuit;
the data processing system further comprising a graphics processor, the graphics processor comprising a programmable execution unit operable to execute processing programs to perform processing operations;
wherein:
   the control circuit of the processor that is configured to perform neural network processing is configured to:
      in response to an indication of particular neural network processing to be performed, cause the programmable execution unit of the graphics processor to execute a program to perform the indicated neural network processing.

The technology described herein relates to the performing of neural network processing in data processing systems that include a processor (e.g. a neural network processing hardware accelerator (neural processing unit, NPU)) that is (specifically) configured to perform neural network processing, and a graphics processor that includes a programmable execution unit operable to execute programs to perform processing operations.

In the technology described herein, a control unit of the neural network processor that in normal operation will distribute neural network processing tasks to execution units of the neural network processor is also operable to, and operates to, in response to indications for particular neural network processing, cause the execution of a (shader) program by the execution unit of the graphics processor to perform the neural network processing operation(s) in question (instead of that neural network processing being performed by an execution unit of the neural network processor), i.e. such that the neural network processing operation(s) is performed by execution of a program by the programmable execution unit of the graphics processor and not by an execution unit of the processor that is configured to perform neural network processing.

The Applicants have recognised in this regard that while a dedicated neural network processor may, as discussed above, be configured to accelerate certain processing, e.g. arithmetic, operations that are used for neural network processing, there may still be some neural network processing operations that a neural network processor is unable to accelerate, e.g. because it does not include the appropriate fixed function hardware (circuits) for those operations (e.g. because it is not cost-effective or efficient to provide fixed function hardware for particular, e.g., relatively rarer, neural network processing operations).

The Applicants have further recognised in this regard that such operations that are not supported in hardware by a neural network processor may instead be able to be performed by the appropriate execution of a (shader) program by a programmable execution unit of a graphics processor that supports the execution of (shader) programs. Thus, when a given, e.g. arithmetic, operation that is required for neural network processing cannot be performed using a fixed function execution unit of a neural network processor, that operation can instead be performed by the execution of an appropriate shader program in an execution core or cores of the graphics processor.

Furthermore, in the technology described herein, the (control unit of the) neural network processor is configured to be able to trigger the desired shader program execution on the graphics processor directly and by itself, when it recognises neural network processing that needs to be performed by means of shader program execution on the graphics processor. This can then avoid, for example, for the neural network processing that is to be performed to have to be broken down, e.g., into separate sets of commands for operations on the neural network processor and the graphics processor, e.g., by the host processor that is controlling the overall operation. Rather, in the technology described herein, even in the case where there is neural network processing that will be required to be performed by shader program execution on the graphics processor, an indication of the required neural network processing that is provided (solely) to the neural network processor can be generated and provided to the neural network processor, with the neural network processor itself then controlling the operation of the graphics processor if and when required.

The effect of this then is to provide a more efficient mechanism for performing neural network processing in such data processing systems and in particular for performing neural network processing where at least some of that processing may not be directly supported in hardware by a dedicated neural network processor of the data processing system.

The processor that is configured to perform neural network processing in the technology described herein can be any suitable and desired processor that is configured to perform neural network processing, e.g., and in an embodiment, that includes processing circuits configured specifically to perform (to more optimally perform) processing operations of a type or types that will (e.g. more commonly) be required for neural network processing. In an embodiment, the processor that is configured to perform neural network processing is a neural network processing hardware accelerator (engine).

The processor configured to perform neural network processing comprises one or more execution units, each configured to perform a processing operation or operations for neural network processing. The processor may comprise any suitable and desired number of such execution units.

Each execution unit is in an embodiment configured to perform a particular, in an embodiment selected, in an embodiment determined, type or types of processing operation that are (e.g. more commonly) encountered during neural network processing (and in an embodiment in an efficient, and in an embodiment more optimal, manner), such as a particular, e.g., tensor, arithmetic operation, and in an embodiment comprises appropriate, in an embodiment fixed function, processing circuits for performing the operation or operations in question. For example, there may be an execution unit that is configured to (and comprises fixed-function processing circuits configured to) perform multiply-accumulate (MAC) operations.

The particular operations that the neural network processor (its execution unit(s)) is configured to perform can be any suitable and desired processing operations that are used for (and useful for) neural network processing.

The processor that is configured to perform neural network processing in an embodiment comprises an (arithmetic) execution unit or units that is configured to (more optimally) perform arithmetic operations, such as, and in an embodiment, tensor arithmetic operations, e.g. of a certain type, that will be more commonly encountered during neural network processing.

In an embodiment the processor comprises, inter alia, an execution unit configured to apply a filter to an input data array and in an embodiment to perform a weighted sum using input data and weight data. In an embodiment, the execution unit(s) is configured to perform a weighted sum as a multiply-accumulate operation, and accordingly comprises one or more multiply-accumulate circuits (otherwise known as a multiplier-accumulator, or an “MAC unit”) for performing a multiply-accumulate operation.

In an embodiment, the processor that is configured to perform neural network processing comprises at least an execution unit that is configured to perform convolution-like arithmetic operations (a fixed function convolution unit), in an embodiment together with one or more other, in an embodiment fixed-function, execution units which are configured to perform other (arithmetic) operations.

In an embodiment the processor that is configured to perform neural network processing comprises one or more of, and in an embodiment plural of, the following execution units: direct memory access units (e.g. to read/write tensors) (and which may include a compression and decompression unit); a weight decode fetches weights and may also include a decompression unit; one or more transform units, e.g. for rearranging data without any effect from the value of individual elements in the data, such as permuting dimensions, duplicating/broadcasting dimensions, inserting/removing dimensions or rearranging data order; one or more elementwise operation units, such as to perform arithmetic operations such as addition, multiplication, etc., logical operations (shifts, etc.), and/or bitwise operations; execution units to perform clamping (ReLU), scaling and/or zero point correction, lookup tables; one or more execution units to perform reduction operations, such as sum, min/max, argmax, argmin, etc.; one or more execution units to perform resize operations, such as scaling H/W dimensions, inserting zeros, replicating neighbours or bilinear filtering.

It would also be possible to have execution units that are able to perform plural of the above operations, such as a vector engine able to implement elementwise reduction and resize, for example.

Other arrangements would, of course, be possible.

The processor that is configured to perform neural network processing also includes a control circuit that is configured to distribute processing tasks to the execution unit or units of the neural processor to cause the execution units to perform processing operations for neural network processing.

Again, this control circuit can take any suitable and desired form, and should be, and is in an embodiment, operable to schedule corresponding processing tasks for, and on, the execution unit or units of the neural network processor in response to an indication of neural network processing to be performed provided to the control circuit. For example, in response to a given indication of neural network processing to be performed, the control circuit may schedule a corresponding processing task for an arithmetic execution unit of the processor, e.g. to cause the (arithmetic) execution unit to perform a tensor arithmetic operation for the neural network processing.

In an embodiment, the control circuit is also operable to and configured to be able to, subdivide an overall neural network processing task to be performed into smaller, sub-tasks, such as, and in an embodiment, respective blocks of neural network processing, for distribution to the execution unit or units of the neural processor (or to the graphics processor, in accordance with the technology described herein).

For instance, in some embodiments, the neural network processing involves subdividing the processing of an initial input data array into one or more, and in an embodiment a plurality of, blocks/sub-blocks. The control unit of the processor that is configured to perform the neural network processing may then cause the execution unit(s) to execute the neural network processing operations for the blocks/sub-blocks, and in an embodiment one after another, until the sequence of operations has been completed for the entire initial input data array. This may be done in any suitable and desired manner.

In an embodiment, the control circuit of the processor that is configured to perform neural network processing is operable to transform a first, e.g., and in an embodiment, multi-dimensional, iteration (operation) space that processing work is defined with respect to, to a respective (different) iteration space of an execution unit of the neural processor that is to perform the processing operation in question, or of the programmable execution unit of the graphics processor, as appropriate.

It will be appreciated in this regard that neural network processing is typically higher dimensional, at least 4D, but the neural execution units may perform operations of various dimensionality, for example from 2D up to 8D. The work to the execution units is despatched to the execution units using their appropriate dimensionality, while iterating through the overall higher dimensional operation space.

In an embodiment, the control circuit operates in this regard so as to sub-divide an overall, common iteration/operation space to generate respective blocks of that space for distributing for processing, with a respective transformation of each individual block to the iteration/operation space for an execution unit then being performed (as and when required). Correspondingly, in the case where a neural network processing task requires the use of multiple operations (multiple execution units) each block in the common iteration/operation space will undergo the appropriate transformation for each execution unit (operation) that it is to be processed by. This will then allow each block that an execution unit sees to relate back to a consistent and common set of blocks from (in) the common iteration/operation space.

As well as the neural network processing operation execution unit or units and the control circuit, the processor that is configured to perform neural network processing may contain any other suitable and desired components, units and elements, etc., e.g., and in an embodiment, that a neural network processor may normally include.

In an embodiment, the neural processor is operable to, and includes one or more processing circuits (units) configured to and operable to, access a memory system and (main) memory of the data processing system, e.g., and in an embodiment, so as to be able to read data from, and write data to, memory of the data processing system. Such memory access units can take any suitable and desired for, and in an embodiment comprise one or more direct memory access (DMA) units (circuits) associated with (of) the processor which is to perform the neural network processing.

(Correspondingly, the data processing system in an embodiment comprises (e.g. main) memory that is operable to and used to store data for neural network processing and that is external to the processor that is performing the neural network processing, e.g. main memory, and that is, in an embodiment, accessed from and by the processor that is configured to perform neural network processing via an appropriate memory access unit or units, and in an embodiment via one or more direct memory access (DMA) units, e.g., and in an embodiment, via a cache hierarchy (a cache system) of the overall memory system.)

In an embodiment, the neural processor includes local storage, in an embodiment in the form of one or more buffers, that is local to the processor that is configured to perform neural network processing and intended and used for storing data locally while an execution unit or units are performing neural network processing. This can be, and is in an embodiment, used to store tensor data, weight data, etc..

This local storage should be, and is in an embodiment, physically (and logically) separate from any (main) memory of the data processing system, and should be, and is in an embodiment, storage that is internal to the processor that is performing the neural network processing and/or that can be accessed by execution unit(s) of the neural processor directly (without the need for a memory access unit (e.g. DMA) (in contrast to the (main) memory)).

In an embodiment, the local storage of the neural processor is managed and configured as a set (series) of, in an embodiment programmatically, definable/configurable data structures in the local storage, where input and/or output data for neural network processing operations can be stored (which data structures will be referred to herein as “pipes”). These data structures (pipes) in an embodiment store one or more buffers, and are in an embodiment in the form of first-in first-out (FIFO) queues (with each buffer being an entry in the (FIFO) queue).

Each such pipe (data structure) (e.g. FIFO queue) in the local storage may, for example, and in an embodiment, act as an input pipe (queue) for a given neural network processing operation and/or as an output pipe (queue) for a neural network processing operation. Thus a given neural network processing operation will in an embodiment have zero (and in an embodiment one) or more pipes (e.g. FIFO queues) in the local storage (defined) as its inputs, and in an embodiment zero or a single, pipe (FIFO queue) in the local storage (defined) as its output. In this regard, the neural network processing operation should have at least one pipe (whether as an input or output), but may not necessarily have both an input and an output pipe or pipes. For example, a load will have an output pipe but not an input pipe and a store will have an input pipe but not an output pipe. Other operations generally and in an embodiment have at least one input pipe and at least one (and in an embodiment a single) output pipe.

A given pipe (FIFO queue) may, and in an embodiment at least in some cases does, act as both an output for one neural network processing operation and an input for another neural network processing operation (e.g., and in an embodiment, where the processing operations follow each other in the sequence of neural network processing operations that are being performed).

In an embodiment parameters for a given “pipe” (buffer/queue), such as, and in an embodiment, the width and height of a “pipe” (FIFO queue) are definable/settable (programmable), e.g., and in an embodiment, by defining (setting) the appropriate parameter(s) for a (and each) such “pipe” (FIFO queue) to be used for a given set of neural network processing as part of and via the defining of and indications for that processing.

These pipe definitions (that configure how the local storage should be allocated across the different buffers for the different pipes) are in an embodiment written by the compiler and form part of the neural network processing operation descriptors. They may be stored in main memory or as state in the command buffer, for example.

In an embodiment each such “pipe” (e.g. FIFO queue) can include one or more buffers, with the number of such buffers again being settable (definable) (programmable) as part of the neural network processing defining process. This will then allow it to be selectively defined and indicated as to whether a given pipe (FIFO queue) should be, for example, double buffered, or higher/lower buffered, e.g. to compensate for latency (such as memory access latency, or pipeline latency where several operations are performed before buffers are needed again). In this regard, each buffer would be an entry in the FIFO queue (so references to first in or first out in the queue refers to buffers as a whole, and a double-buffered pipe correspondingly means a FIFO of size 2).

In the case where, as discussed above, an overall neural network processing “task” is subdivided into plural individual blocks of work for processing purposes, then in an embodiment each block of work will have its own respective entry or entries (buffer or buffers) in a given pipe (data structure) (e.g. FIFO queue) in the local storage of the neural processor.

In an embodiment, the buffers of a given pipe (FIFO queue) are (in an embodiment directly) related to the blocks of work (the block iteration) that is used for the neural network processing, discussed above. In an embodiment, each block has a one-to-one mapping with a buffer in a respective pipe (FIFO queue) in the local storage for the sequence of neural network processing that the block in question is to undergo. In this regard, a block execution might use multiple inputs, in which case it will, and in an embodiment does, consume multiple buffers in the local storage, in an embodiment each from separate pipes (in an embodiment a block does not consume two different buffers from the same pipe).

Correspondingly, a block may and in an embodiment does, output a single buffer into its destination pipe in the local storage (although again there could be multiple output pipes, if desired).

Correspondingly, the indications of neural network processing to be performed that are provided to the control unit of the processor configured to perform neural network processing can, and in an embodiment do, include appropriate indications of the, e.g., and in an embodiment, number and configuration of “pipes” that should be provided and used in the local storage of the neural processor when performing the neural network processing in question.

The graphics processor in the technology described herein can be any suitable and desired graphics processor that includes a programmable execution unit operable to execute (shader) programs to perform processing operations. The graphics processor may otherwise be configured and operable as desired, and be configured to execute any suitable and desired form of graphics processing pipeline (in its normal graphics processing operation).

The programmable execution unit of the graphics processor may be any suitable and desired such execution unit, such as, and in an embodiment, an appropriate execution engine of an execution core of the graphics processor. Thus, the programmable execution unit of the graphics processor is in an embodiment part of and comprised in an appropriate (shader) execution (processing) core of the graphics processor. The graphics processor may comprise a single programmable execution unit (and execution core), or plural execution units (and execution cores), as desired.

The graphics processor (its execution core(s)), may, for example, and in an embodiment, comprise further components and units necessary for the execution of (shader) programs, such as, for example, and in an embodiment, local storage for storing data for use by execution threads when the execution unit is executing a (shader) program, in an embodiment in the form of a register file, and a load/store unit (circuit) operable to load and store data for use (e.g. from memory to the local storage (register file) and from the local storage to memory), when executing a program.

The graphics processor in an embodiment also comprises an appropriate control unit (circuit) that is operable to, and configured to, control the execution of programs to perform processing operations by the execution unit of the graphics processor. In an embodiment, this control unit is in the form of an appropriate thread group (warp) manager that is operable to create (spawn) groups of execution threads for execution, and schedule and control the execution of (shader) programs by such groups of threads by the programmable execution unit.

The processing operations that are performed by the execution of a program by the graphics processor can be any suitable and desired processing operations that may be required for neural network processing. They are in an embodiment operations that are not (directly and explicitly) supported by the neural processor, such as, and in an embodiment, operations that cannot be performed by an execution unit of the neural processor.

In one embodiment, the processing operations that are performed by the execution of a program(s) by the graphics processor comprise operations that use a different precision and/or number format to the precision and/or number format that is supported by the execution units of the neural processor. For example, the neural processor may only support integer-based arithmetic operations, such that any operations that are to be performed using floating point values would then instead be performed by the execution of a program or programs by the graphics processor.

In an embodiment, the operations that are performed by program execution on the graphics processor comprise one or more of, and in an embodiment plural of: loading and compressing data values from a compressed frame buffer (and conversely, compressing and storing data values to a compressed frame buffer) to use as an input (or output) of a neural network; performing colour-space conversion; image filtering (e.g. high quality image filtering, e.g. bicubic filtering); sorting of elements within a tensor along one or more axes; hashing functions and hash table lookups; seldomly used neural network operations (such as gather loads and scatter stores, trigonometric/transcendental functions using floating point numbers, etc.).

The processor that is configured to perform neural network processing and the graphics processor may be distinct and separate processing units, such that the data processing system will comprise a stand-alone graphics processing unit (GPU) and a stand-alone neural processing unit (NPU)

However, in an embodiment, the processor that is configured to perform neural network processing is coupled to and integrated with the graphics processor, for example, and in an embodiment, in the form of a neural engine that is provided as part of and integrated with the graphics processor. As will be discussed further below, in an embodiment, the graphics processor execution (shader) cores and neural engine or engines sit behind the same combined control circuit/frontend/host interface, and are connected together on the same internal interconnect.

In this case, there will, in effect, and in an embodiment, be a graphics processor that additionally includes the processor that is configured to perform neural network processing of the technology described herein, in an embodiment in the form of an appropriate neural engine that is associated with and configured as part of the graphics processor.

Correspondingly, the graphics processor will comprise one or more (shader) execution cores, together with one or more neural processors (neural engines). In an embodiment, each (shader) execution core of the graphics processor has an (its own) associated and coupled neural processor (neural engine).

In this case, a (shader) execution core of the graphics processor and its associated neural engine (neural processor) in an embodiment share at least some, in an embodiment particular, in an embodiment selected, components and elements, such that those components and elements will be provided in common for the execution core and neural processor (engine), rather than there being separate such components/elements for the execution core and the neural processor.

In an embodiment, the shader execution core and neural processor (engine) have access to a shared (share a) cache (e.g. an L1 cache) of the overall memory system hierarchy of the data processing system, via which they are operable to read data from, and write data to, memory of the data processing system. This shared (e.g. L1) cache should be, and is in an embodiment, distinct from and not the same as, any specific (dedicated) local storage of the neural processor (engine) (and graphics processor) (as discussed above).

The execution core and neural engine may also, and in an embodiment do also, share a bus interface and interconnect to other components of the data processing system, such as the memory system of the data processing system.

In an embodiment, the submission of processing work for the graphics processor and neural processor is controlled using “command” stream(s), that may, for example, include commands (instructions) to set parameters for processing jobs, as well as commands (instructions) to execute the processing jobs. Such command streams may be generated by a host processor and written to appropriate command stream storage, e.g. in (main) system memory, and then read therefrom for processing.

Correspondingly the system in an embodiment includes one or more “command stream frontends”, e.g., and in an embodiment, each comprising a “command stream execution unit”, for interpreting and implementing the command streams.

A command stream execution unit may, for example, work its way through a command stream, executing, in turn, the commands (instructions) in the command stream and causing the operations indicated by the commands to be performed.

There could in this regard be separate frontend control units (command stream frontends) for the graphics processor and the neural processor, respectively, but in an embodiment, there is common (shared) frontend control unit (command stream frontend) that is operable to receive commands from an, e.g., host processor, and in response to those commands then distribute processing tasks respectively to a (shader) execution core or cores of the graphics processor or to the neural processor (e.g. neural engine of the graphics processor) accordingly and as appropriate.

In this case therefore, the common, shared frontend control unit (command stream frontend) will identify commands relating to neural network processing, and then distribute such commands (or the work required for those commands) to the control unit of the processor that is configured to perform neural network processing (of the neural engine), for that control unit to then cause the neural processor (the neural engine) to perform the necessary neural network processing, and, correspondingly, for non-neural network-related graphics processing tasks, correspondingly identify commands relating to graphics processing tasks and distribute those tasks appropriately to a control unit (e.g. thread group manager) of an execution core or cores of the graphics processor for those tasks to thereby be performed.

It should be noted here that such a command stream frontend (command stream execution unit) will accordingly be, and is in an embodiment, distinct from and separate to the control unit of the neural processor that distributes processing tasks to execution units of the neural processor (or to the graphics processor), and correspondingly to the corresponding control unit (e.g. thread group (warp) manager) of the graphics processor.

In an embodiment, the command stream frontend (command stream execution unit) is provided with higher level commands indicative of processing tasks to be performed, and then provides those tasks appropriately to the control unit of the neural engine or of the graphics processor, for those control units to then distribute the particular processing tasks necessary to the appropriate execution units and to schedule the performance of those processing tasks on the execution units.

Thus there will, in effect, and in an embodiment, be a suitable control unit, in an embodiment in the form of a command stream frontend, that receives indications of processing tasks to be performed from an, e.g. host processor, and that in response to those commands distributes processing tasks to the control units of the individual processors (the graphics processor and the neural processor), as appropriate, with those control units (circuits) of the individual processors then causing the processing tasks to be performed appropriately (as discussed above).

In the technology described herein, the control circuit of the neural processor is operable to distribute processing tasks to the execution unit or units of the neural processor (or, alternatively, to the graphics processor) in response to respective indications of processing operations for neural network processing to be performed provided to the control circuit.

The indications of neural network processing to be performed that are provided to the control circuit of the neural processor can take any suitable and desired form. They should, and in an embodiment do, at least indicate the (neural network) processing operation or operations to be performed, the relevant input data (input data arrays) to be used for the respective processing operations (such as respective input feature maps, sets of weights, etc.), where any output data (output data arrays (output feature maps)) of a processing operation is to be stored, and any other parameters (e.g. state) necessary for performing the processing operation or operations in question. Indications could also indicate, for example, one or more of: state relating to the control of debug/instrumentation/processing features and/or how faults should be managed; the format and/or layout of input and output tensors in memory; compression metadata; and an affinity mask to indicate which subset of cores a job should be scheduled on to.

This information can be provided to the control circuit of the neural processor in any suitable and desired form. For example, an appropriate set of commands and other, e.g. state, information that conveys this information and the operations to be performed could be conveyed to and provided to the control unit of the neural processor.

In an embodiment, the indications of the neural network processing to be performed are in the form of one or more sets of neural network processing information, in an embodiment in the form of one or more neural network processing data structures (descriptors) (in memory), with each such set of information (descriptor) in an embodiment indicating a sequence of one or more processing operations to be performed for the neural network processing, an indication of the data inputs and outputs (e.g., and in an embodiment, where the data is to be read from and stored to) for each operation in the sequence indicated by the set of information (descriptor), and an indication of the location in memory of the initial input to the sequence of operations and/or of where the output from the sequence of operations should be stored (in memory).

The indications of the operations to be performed can indicate any suitable and desired operations that may be required to be performed when performing neural network processing using the neural processor. It is in an embodiment possible to indicate a requirement to perform one or more of, in an embodiment plural of, and in an embodiment all of, the following operations: reads from memory; writes to memory; and any of the operations for which there is a particular (fixed function) execution unit in the neural processor, such as a convolution operation or any of the other neural network processing operations discussed above. The indications of neural network processing to be performed may also, and in an embodiment do also, indicate the size of the space (the iteration space) that the neural network processing is to be performed over.

The information indicating the operations to be performed can convey any suitable and desired information for defining the operation(s) that is to be performed. They in an embodiment indicate at least the type of operation to be performed, any necessary attributes or parameters for that operation, the location of any inputs and/or outputs for the operation, and the “iteration” space over which the operation is to be performed.

The information indicating the location of the inputs and outputs for the processing operations for the neural network processing can correspondingly take any suitable and desired form. In the case where an input or output relates to (main) memory of the data processing system, the information in an embodiment comprises suitable information for locating the data in memory, such as an indication of a memory address where the data is stored/is to be stored, an indication of the layout that the data will have in the memory, an indication of the size of the data in memory, and/or an indication of the type of the data in question.

In an embodiment, in particular in the case where, as discussed above, the neural processor includes its own local storage that can, in effect, be used independently of the (main) system memory when performing neural network processing, an indication of the location of input and output data for a processing operation can indicate an appropriate location for that data within the local storage of the neural processor (rather than in (main) memory).

Thus, in an embodiment, an indication of neural network processing to be performed can indicate that input data for a processing operation should be retrieved from the local storage of the neural processing (and where in the local storage of the neural processor that data should be retrieved from), and correspondingly that output data from a processing operation should be stored in the local storage of the neural processor (and where in the local storage of the neural processor that output data should be stored). Such “local storage” indications in an embodiment identify a set of local storage data, which set of data is then otherwise defined, e.g. by an appropriate descriptor for the set of data.

As discussed above, in an embodiment, the “local storage” indications identify and define respective data structures (pipes) (and in an embodiment FIFO queues) to be used and configured in the local storage, such as, for example, and in an embodiment, for each such pipe providing an identity for the pipe, a number of buffers in the pipe, and the location (address) of the pipe in the local storage, such as, and in an embodiment, a base address for the start of the pipe in the local storage.

Correspondingly, in this case at least, the indication of a processing operation to be performed in an embodiment indicates for that processing operation which pipe or pipes (data structure(s)) (FIFO queue or queues) in the local storage should be used as an input to the operation and/or which pipe or pipes should be used as an output for the operation.

In an embodiment, there can be a set (sequence) of plural such sets of neural network processing information (descriptors), which are, e.g., and in an embodiment, acted upon in turn by the control unit of the neural processor to cause the desired neural network processing operations to be performed.

The indications of the neural network processing to be performed that are provided to the control unit of the neural processor can be prepared in any suitable and desired manner. In an embodiment the necessary indications of neural network processing to be performed are generated from a higher level, e.g. graph-based, description of the neural network processing to be performed, in an embodiment by means of an appropriate compilation process. Thus, a higher level, e.g. graph-based, description of neural network processing to be performed is compiled into an appropriate “lower level” set of indications of neural network processing to be performed (e.g. one or more neural network processing descriptors as discussed above), that can then be appropriately interpreted and used by the control unit of the neural processor to trigger and control the necessary neural network processing.

Thus, the preparation of the indications of neural network processing to be performed is in an embodiment done by a compiler for the neural processor, which compiler may, e.g., and in an embodiment, be executed on an appropriate processor (e.g. CPU) of a data processing system (e.g. of the data processing system that the neural processor is part of, or of a separate data processing system, as desired).

The compilation process may be, and is in an embodiment, performed in advance of any execution and performing of the neural network processing itself, in an “offline” manner. Thus (at least some of) the compilation process is in an embodiment done in advance of runtime, rather than at runtime for the neutral network in question. Correspondingly, (at least some of) the compilation process and compiler in an embodiment executes separately and in advance of running the driver (the driver operation for the processor that is to perform the neural network processing).

Thus, in an embodiment, the compiler operation will prepare in advance the indications of neural network processing to be performed, and then, for example, and in an embodiment, store those indications (e.g. neural processing descriptors) for future use.

Then, e.g., at runtime, the, e.g., driver, will identify and determine the neural network processing to be performed (e.g. based on a request for neural network processing, e.g. from an application requiring neural network processing, e.g. executing on a host processor (CPU) of the data processing system), and issue an appropriate command or commands that will cause the control unit of the neural processor to access the appropriate indications of neural network processing to be performed and then cause that neural network processing to be appropriately performed.

Thus, in an embodiment, the indications of neural network processing to be performed are provided to the control unit of the neural processor by storing those indications appropriately in memory, with the indications then being retrieved appropriately from memory by the control unit of the neural processor and acted upon accordingly, when the desired neural network processing is to be performed.

In an embodiment, the compilation process and the compiler is also configured to, and operates to, prepare and store any associated data structures necessary for the neural network processing (and to include in the indications of neural network processing to be performed, appropriate indications of those data structures).

Thus, in an embodiment, any appropriate data structures, e.g., comprising the desired input feature maps and/or weight arrays (filters) to be used for the neural network processing are also prepared and, e.g., and in an embodiment, stored appropriately in memory. Correspondingly, appropriate indications of the locations of the required data structures are in an embodiment also generated.

Depending upon the nature of the data structures and the data and, e.g., whether it can be generated in an “offline” manner in advance, or will only be known/available at runtime, such data structures may be generated and/or stored in advance, in an “offline” manner, or they may, e.g., be generated and/or stored, e.g., and in an embodiment, by the driver, at runtime, e.g. as a just-in-time process, as appropriate. Thus, for example, and in an embodiment, as well as at least some of the indications of neural network processing to be performed being able to be and being generated in advance, in an “offline” manner, there may be at least some indications of neural network processing to be performed that are generated at runtime, e.g., and in an embodiment, by the driver for the neural processor. Other arrangements would, of course, be possible.

When neural network processing is required, the control unit of the neural processor can be triggered to, e.g., read the necessary indications of neural network processing to be required from memory (and to then process those indications) in any suitable and desired manner. Particularly in the case where there is a frontend control unit (a command stream frontend) that is operable to distribute processing tasks to the control unit of the neural processor, this is achieved by including an appropriate command in the sequence of commands (in the command stream) that is provided to the frontend control unit (the command stream frontend), e.g. such as a “run neural network of a particular type” command, in response to which the frontend control unit (command stream frontend) will indicate to the control unit of the neural processor the particular neural network processing to be performed (e.g. where it should read the relevant indications of the neural network processing to be performed from, with the control unit then reading the relevant neural network processing indications and operating accordingly).

In this case therefore, and in an embodiment, the, e.g., and in an embodiment, driver for the neural processor will recognise a request for particular neural network processing to be performed, and include in the command stream that is provided to the command stream frontend for the neural processor, an appropriate command or commands indicating that required neural network processing.

Other arrangements would, of course, be possible.

As discussed above, in the technology described herein, the control circuit of the neural processor is operable to cause the execution unit of the graphics processor to execute a program to perform indicated neural network processing in response an indication of neural network processing to be performed. The control circuit can be caused to operate in this manner in any suitable and desired manner. For example, the control circuit could be operable and configured to determine whether indicated neural network processing can be performed by the neural processor, and to, when it determines that the processing cannot be performed by the neural processor, to instead cause a program to be executed by the programmable execution unit of the graphics processor.

In an embodiment, the indications of neural network processing to be performed that are provided to the control circuit can, and where appropriate do, indicate that a neural network processing operation should be performed by the programmable execution unit of the graphics processor executing a program to perform that neural network processing operation.

Thus, for example, and in an embodiment, where the indication provided to the control unit of the neural processor includes information indicating processing operations to be performed, the indication of a processing operation to be performed can indicate that the processing operation is to be performed by execution of a program by the programmable execution unit of the graphics processor (rather than by an execution unit of the processor that is configured to perform neural network processing).

Thus, for example, and in an embodiment, where the indications of neural network processing to be performed comprise a descriptor or descriptors of neural network processing to be performed, in an embodiment a descriptor can indicate in respect of a given indicated neural network processing operation, that that processing operation comprises (and is to be performed by) execution of a (shader) program by the programmable execution unit of the graphics processor.

Then, in response to such an indication, the control circuit of the neural processor will cause the programmable execution unit of the graphics processor to execute the appropriate program to perform the processing operation for the neural network processing.

Thus, in an embodiment, the method of the technology described herein comprises the control circuit of the processor that is configured to perform neural network processing (and the control circuit of the neural processor is correspondingly configured to) in response to an indication of neural network processing to be performed by execution of a program by the programmable execution unit of the graphics processor, causing the programmable execution unit of the graphics processor to execute a program to perform the neural network processing.

In an embodiment, as well as the indication of neural network processing indicating that the processing operation should be performed by the programmable execution unit of the graphics processor executing a program (such that the control unit can recognise that), the indication provided to the control circuit of the neural processor in an embodiment also indicates any further and additional information that may be required for the execution of the program by the programmable execution unit of the graphics processor, such as, inter alia, and in an embodiment, one or more of, and in an embodiment all of: an indication of the (shader) program to be executed; an indication of any attributes or parameters required for the (shader) program execution; and an indication of the iteration space (e.g. thread space) that the program should be executed for.

As discussed above, in embodiments of the technology described herein the indications of neural network processing to be performed provided to the control circuit of the neural processor can include indications of processing operations that are to be performed by execution of a program by the programmable execution unit of the graphics processor. Thus, the indications of neural network processing to be performed that are provided to the control circuit will include, where necessary, particular indications indicating processing that should be performed by execution of a program by the programmable execution unit of the graphics processor, and in response to such indications, the control circuit will cause the relevant program execution to be performed by the programmable execution unit of the graphics processor.

Such indications can be generated for and provided to the control circuit of the neural processor in any suitable and desired manner. As discussed above, in an embodiment this is done as part of an (overall) neural network processing “compilation” process, where, for example, and in an embodiment, a higher level, e.g. graph-based, description of the neural network processing that is to be performed is converted to a lower level description comprising a set of one or more indications (e.g. a set of one or more descriptors) that will be provided to the control circuit of the neural processor to indicate to the control circuit the neural network processing that is to be performed.

Thus, in an embodiment, there will be a stage of preparing a set of one or more indications of neural network processing to be performed for provision to the control circuit of the neural network processor, with that set of indications then subsequently being provided to the control circuit, and the control circuit in response to the provided indications causing the desired neural network processing to be performed (either by the neural processor itself, or by a combination of the neural network processor and the execution of a program or programs by the programmable execution unit of the graphics processor).

In an embodiment this comprises for a (and in an embodiment for each) processing operation to be performed for the neural network processing indicated by a (the) higher level description of the neural network processing, determining whether the required operation can be performed by an execution unit of the processor that is configured to perform neural network processing, and when it is determined that the required processing operation can be performed by an execution unit of the processor that is configured to perform neural network processing, including an indication of that operation that will cause the control circuit to cause the operation to be performed by an execution unit of the processor that is configured to perform neural network processing in a set of indications of neural network processing to be performed, and when it is determined that the required processing operation cannot be (can other than be) performed by an execution unit of the processor that is configured to perform neural network processing, including for that processing operation in the set of indications of neural network processing to be performed an indication that indicates that the processing operation should be performed by execution of a program by the programmable execution unit of the graphics processor.

This may be, and is in an embodiment, repeated, for each operation indicated by the higher level description of the neural network processing, to thereby prepare a set of indications (e.g. a set of one or more neural network processing descriptors) indicating neural network processing to be performed for providing to the control circuit of the neural processor corresponding to the neural network processing defined by the higher level description of that processing.

The technology described herein extends to such generation of an appropriate set of indications of neural network processing for provision to a control unit of a neural processor (that is configured to operate in the manner of the technology described herein).

Thus, another embodiment of the technology described herein comprises a method of generating from a higher level description of neural network processing to be performed, a set of indications of neural network processing to be performed for providing to a control circuit of a processor that is configured to perform neural network processing that comprises one or more execution units configured to perform processing operations for neural network processing; and a control circuit configured to distribute processing tasks to the execution unit or units to cause the execution units to perform processing operations for neural network processing in response to indications of neural network processing to be performed provided to the control circuit;
the method comprising:
for a processing operation to be performed for the neural network processing indicated by the higher level description of the neural network processing:
   determining whether the processing operation can be performed by an execution unit of the processor that is configured to perform neural network processing, and
   when it is determined that the processing operation can be performed by an execution unit of the processor that is configured to perform neural network processing, including an indication that will cause the control circuit to cause the operation to be performed by an execution unit of the processor that is configured to perform neural network processing in a set of indications of neural network processing to be performed; and
   when it is determined that the processing operation cannot be performed by an execution unit of the processor that is configured to perform neural network processing, including for that processing operation in the set of indications of neural network processing to be performed an indication that will cause the control circuit to cause the processing operation to be performed by execution of a program by a programmable execution unit of a graphics processor.

Another embodiment of the technology described herein comprises an apparatus for generating from a higher level description of neural network processing to be performed, a set of indications of neural network processing to be performed for providing to a control circuit of a processor that is configured to perform neural network processing that comprises one or more execution units configured to perform processing operations for neural network processing; and a control circuit configured to distribute processing tasks to the execution unit or units to cause the execution units to perform processing operations for neural network processing in response to indications of neural network processing to be performed provided to the control circuit;
the apparatus comprising processing circuits configured to:
for a processing operation to be performed for neural network processing indicated by a higher level description of neural network processing:
   determine whether the processing operation can be performed by an execution unit of a processor that is configured to perform neural network processing, and
   when it is determined that the processing operation can be performed by an execution unit of the processor that is configured to perform neural network processing, include in a set of indications of neural network processing to be performed an indication that will cause a control circuit of processor that is configured to perform neural network processing to cause the operation to be performed by an execution unit of the processor that is configured to perform neural network processing; and
   when it is determined that the processing operation cannot be performed by an execution unit of the processor that is configured to perform neural network processing, include for that processing operation in the set of indications of neural network processing to be performed an indication that will cause the control circuit to cause the processing operation to be performed by execution of a program by a programmable execution unit of a graphics processor.

As will be appreciated by those skilled in the art, these embodiments of the technology described herein can and in an embodiment do include any one or more or all of the optional features of the technology described herein described herein, as appropriate.

Thus, for example, the higher level description of the neural network processing in an embodiment comprises a graph-based description of the neural network processing. Correspondingly the set of indications of neural network processing to be performed in an embodiment comprises a set of neural network descriptors, as discussed above.

Similarly, the set of indications of neural network processing are in an embodiment provided to the control unit of the processor that is configured to perform neural network processing by storing the set of indications appropriately in memory from where they can then be (and are) retrieved by the control circuit of the neural processor.

In these embodiments of the technology described herein, it can be determined whether an operation for neural network processing can be performed by an execution unit of the neural processor or not in any suitable and desired manner. For example, it may be possible for the higher level description of the neural network processing to be such that that higher level description can indicate directly processing operations that cannot be performed by an execution unit of the neural processor (such that this operation would then, in effect, be exposed to the higher level neural network defining process).

Additionally or alternatively, and in an embodiment, the neural network compilation process is configured to be able to, and operates to, itself identify processing operations that are unable to be performed by execution units of the neural processor, and to then indicate that those operations should be performed by program execution on an execution unit of a graphics processor instead.

Other arrangements would, of course, be possible.

In the case where a processing operation for neural network processing is to be performed by execution of a program by a programmable execution unit of a graphics processor, the process in an embodiment also comprises determining (identifying) a (the) (shader) program that is to be executed to perform the required processing operation for the neural network processing (and then including an indication of that determined (selected) (shader) program with the indications of neural network processing to be performed).

To support this, there may be, and is in an embodiment, a set (a library) of (pre-prepared) appropriate (shader) programs for performing processing operations for neural network processing, from which the (shader) program that is to be used can be selected.

Thus, in embodiments, in the case where a processing operation for neural network processing is to be performed by execution of a program by a programmable execution unit of a graphics processor:
selecting a program that is to be executed to perform the required processing operation for the neural network processing from a set of programs for performing processing operations for neural network processing; and
including an indication of that selected program with the indication of neural network processing to be performed.

The technology described herein also extends to the combined operation of the neural network processing compilation process, and then the subsequent execution of the neural network processing in the manner of the technology described herein.

Thus, a further embodiment of the technology described herein comprises a method of operating a data processing system, the data processing system comprising:
a processor that is configured to perform neural network processing, the processor comprising:
   one or more execution units configured to perform processing operations for neural network processing; and
   a control circuit configured to distribute processing tasks to the execution unit or units to cause the execution units to perform processing operations for neural network processing in response to indications of neural network processing to be performed provided to the control circuit;
the data processing system further comprising a graphics processor, the graphics processor comprising a programmable execution unit operable to execute processing programs to perform processing operations;
the method comprising:
   including in a set of indications of neural network processing to be performed that is provided to the control circuit of the processor that is configured to perform neural network processing, an indication that a processing operation for the neural network processing should be performed by execution of a program by the programmable execution unit of the graphics processor; and
   the control circuit of the processor that is configured to perform neural network processing, in response to that indication, causing the programmable execution unit of the graphics processor to execute a program to perform the indicated neural network processing operation.

Another embodiment of the technology described herein comprises a data processing system, the data processing system comprising:
a processor that is configured to perform neural network processing, the processor comprising:
   one or more execution units configured to perform processing operations for neural network processing; and
   a control circuit configured to distribute processing tasks to the execution unit or units to cause the execution units to perform processing operations for neural network processing in response to indications of neural network processing to be performed provided to the control circuit;
the data processing system further comprising a graphics processor, the graphics processor comprising a programmable execution unit operable to execute processing programs to perform processing operations;
wherein:
   the data processing system further comprises a processing circuit or circuits configured to provide to the control circuit of the processor that is configured to perform neural network processing a set of indications of neural network processing to be performed that includes an indication that a processing operation for the neural network processing should be performed by execution of a program by a programmable execution unit of the graphics processor; and
   the control circuit of the processor that is configured to perform neural network processing is configured to:
      in response to that indication, cause the programmable execution unit of the graphics processor to execute a program to perform the indicated neural network processing.

As will be appreciated by those skilled in the art, these embodiments of the technology described herein can and in an embodiment do include any one or more or all of the optional features of the technology described herein described herein, as appropriate.

As discussed above, in the technology described herein, the control unit of the neural processor will, in response to an indication of neural network processing to be performed by execution of a program by the programmable execution unit of the graphics processor, cause the execution of the appropriate program by the execution unit of the graphics processor.

The control circuit of the neural processor can cause the programmable execution unit of the graphics processor to execute the required program to perform the processing operation(s) for the neural network processing in any suitable and desired manner. In an embodiment, the control circuit causes appropriate (control) messages to be sent to the graphics processor, and in an embodiment to a control unit (thread group (warp) manager) of the graphics processor, to thereby cause the necessary (shader) program execution to be performed.

Such messages may be sent, for example, over an appropriate message fabric of the data processing system (and, e.g., graphics processor).

In an embodiment, there is an appropriate control interface between the neural processor and the graphics processor that facilitates and provides a mechanism for communication between the neural processor and the graphics processor for this purpose. In an embodiment the neural processor includes an appropriate interface unit (a (shader) program despatch unit) that is in communication with and has an interface with the control unit (the thread group (warp) manager) of the graphics processor, to thereby communicate with the thread group (warp) manager) of the graphics processor and cause the control unit (thread group (warp) manager of the graphics processor to trigger the appropriate (shader) program execution for neural network processing when required. In this case, the control unit of the neural processor in an embodiment communicates appropriately with the communication interface (program despatch) unit to cause that unit to thereby communicate with the control unit (warp manager) of the graphics processor, to thereby cause the appropriate program execution on the graphics processor to be performed.

Thus, in an embodiment, the control circuit of the neural processor is operable and configured to indicate the processing work for the graphics processor to a messaging/interface unit (circuit) that communicates with the control unit (thread group (warp) manager) of the graphics processor, with the messaging/interface unit of the neural processor then communicating appropriately with the control unit (thread group (warp) manager) of the graphics processor to cause the desired program execution to be performed.

In an embodiment, the control circuit of the neural processor subdivides the overall neural network processing task that is to be performed by the graphics processor into appropriate blocks of work within the graphics processor's program execution coordinate system (space), such as, and in an embodiment, into respective blocks of three-dimensional execution thread ID space. It in an embodiment then issues respective blocks of such work to the messaging/interface unit, for the messaging/interface unit to then “send” those blocks of work to the graphics processor for program execution.

As discussed above, in an embodiment, the blocks for processing are in an embodiment generated in a (typically higher dimensional) overall iteration/operation space, but then those blocks in that overall iteration/operation space will be transformed into the graphics processor's operation/iteration space (three-dimensional execution thread ID space) before being despatched for processing.

The control unit of the neural processor in an embodiment conveys any and all required information for the execution of the (shader) program appropriately to the messaging/interface unit of the neural processor.

This information may, and in an embodiment does, comprise one or more of, in an embodiment plural of, and in an embodiment all of, the following: an identifier for the processing task (the block of processing) that the shader program is being executed to perform; an indication of the iteration space over which the shader program execution should be performed within the graphics processor's program execution coordinate system (space); an indication of the (shader) program to be executed, e.g., and in an embodiment, in the form of a pointer to a (e.g. descriptor for the) program in memory; an indication of any state or other information needed for the (shader) program execution (this may be, and is in an embodiment, provided as part of the descriptor for the (shader) program that is stored in memory); an indication of any other information, such as resource information, that may be needed for the program execution, again, e.g., and in an embodiment, in the form of a pointer to appropriate to that information (e.g. a resource table) in memory; and information describing any inputs and outputs (input sources and output sources) for the processing operation in question, e.g., and in an embodiment, in terms of where and how such inputs and outputs are stored/are to be stored.

In response to an appropriate indication from the control unit of the neural processor, the messaging/interface unit will then communicate appropriately with the control unit (thread group (warp) manager) of the graphics processor to cause the necessary shader program execution to be performed.

In an embodiment, the communication from the neural processor to the graphics processor is in respect of and to trigger the issuing of respective thread groups (warps) that are then to execute the program to perform the neural network processing. Thus in an embodiment a separate communication (message) is sent to the graphics processor for each thread group (warp) that is to execute the shader program.

As discussed above, in embodiments of the technology described herein at least, a block of work is despatched to the graphics processor for program execution, which block of work would typically comprise many thread groups (warps). In one embodiment, the control unit of the neural processor sends a block of work to the messaging/interface unit, which then, in an embodiment, iteratively sends communications (messages) to create thread groups to the appropriate control unit (warp manager) of the graphics processor execution core. It would alternatively be possible to send a communication (message) that describes more than a single thread group (such as the whole block of work) to the appropriate control unit (e.g. warp manager) of the graphics processor, with that control unit then iteratively creating the individual thread groups that are to execute the program to perform the processing operation for the entire block of work.

Any communication to the control unit of the graphics processor for a thread group (warp) that is to execute a shader program should, and in an embodiment does, convey any and all required information for the execution of the (shader) program appropriately to the graphics processor (to the control unit (warp manager) of the graphics processor).

This information may, and in an embodiment does, comprise one or more of, and in an embodiment plural of, and in an embodiment all of, the following: an identifier for the processing task that the shader program is being executed to perform; an indication of the (shader) program to be executed, e.g., and in an embodiment, in the form of a pointer to a (e.g. descriptor for the) program in memory; an indication of any state or other information needed for the (shader) program execution; an indication of any other information, such as resource information, that may be needed for the program execution, again, e.g., and in an embodiment, in the form of a pointer to that information (e.g. a resource table) in memory; the coordinates in the graphics processor's thread space of the threads that are to be executed for the thread group (warp), in an embodiment in the form of the coordinate of a, e.g. the first, thread to be executed for the thread group, and, where required, an indication of which threads in the thread group in question, should be run, for example, and in an embodiment, in the form of a bit mask.

In response to an appropriate communication from the (messaging/interface unit of the) neural processor, the graphics processor (the control unit (warp manager) of the graphics processor) should, and in an embodiment does, spawn appropriate threads and thread groups to execute the (shader) program for performing the neural network processing. Such spawning of threads and thread groups and the execution of the program to perform the processing operations for the neural network processing can be performed and proceed in any suitable and desired manner, such as, and in an embodiment, in accordance with the normal manner for (shader) program execution in the graphics processor and graphics processing system in question. Thus, subject to any particular requirements in accordance with the technology described herein, the program execution by the programmable execution unit of the graphics processor may, and in an embodiment does, proceed and operate in the normal manner for (shader) program execution in the graphics processor in question.

The program execution for performing the processing operation for the neural network processing should, and in an embodiment does, use the appropriate input data indicated by the communication from the neural processor, and correspondingly store any output data generated by the program execution where indicated in the communication by the neural processor relating to the program execution.

There may also be, and is in an embodiment, appropriate “hand shaking” and control communication between the (control unit of) the neural processor and the (control unit of the) graphics processor, for example, and in an embodiment, to track the execution of the program to perform the neural network processing, e.g., and in an embodiment, to ensure that the program is executed for the entirety of the iteration (thread) space that it is to be executed over, and to determine when the execution over the required iteration space (thread space) has been completed. For example, and in an embodiment, the control circuit of the neural processor may delay execution of further neural network processing operations by execution units of the neural processor until it is determined that the program execution has been appropriately completed.

In an embodiment, the execution of the program to perform the neural network processing is tracked, in an embodiment for and in respect of a (and each) thread group (warp) that is to execute the program. Thus in an embodiment, the graphics processor (e.g. the thread group (warp) manager of the graphics processor) will indicate to the neural processor when a respective thread group (warp) has completed execution of the program to perform the indicated neural network processing. This “completion” indication in an embodiment comprises an identification of the task that the thread group which has completed relates to, and which thread group for that task has completed.

Additionally or alternatively, there could be a “completion” indication in respect of an entire block of work that is returned to the neural processor, for example in the case where respective blocks of work are communicated to the graphics processor (rather than individual thread groups).

The Applicants have further recognised that when operations for neural network processing are being performed by execution of a program by the programmable execution unit of the graphics processor, that program execution may, and typically will, require input data which may, for example, and in an embodiment, be data that has been generated by other processing operations for the neural network processing that may, e.g., have been performed by an execution unit or units of the neural processor.

Correspondingly, an output generated by the program execution on the graphics processor may then be required as an input for further processing operations for the neural network processing, e.g. that may be performed by an execution unit or units of the neural processor.

Thus in an embodiment, there is, a mechanism for transferring data between (execution units of) the neural processor and (the programmable execution unit of) the graphics processor.

While it would be possible for such data transfer to be performed via the memory system of the data processing system that the graphics processor and neural processor are part of (e.g. by storing the data appropriately in the memory system and then retrieving it therefrom, as required), in an embodiment, data can be, and is, transferred between the neural processor and the graphics processor for the purposes of the operation of the technology described herein using the (dedicated) local storage (buffer) of the neural processor (as discussed above).

In particular, in an embodiment, the graphics processor, and in an embodiment the appropriate (shader) execution core of the graphics processor, is able to load data from and store data to the local storage of the neural processor, and in particular, and in an embodiment, to do that directly via the local storage of the neural processor (without any access or use of the memory system (e.g. cache hierarchy), of the data processing system).

In an embodiment, data can be loaded from the local storage of the neural processor to appropriate local storage for the programmable execution unit of the graphics processor, such as a set of registers (a register file) of and for the programmable execution unit of the graphics processor. Correspondingly, data can in an embodiment be stored (directly) from the local storage, e.g. registers, of the programmable execution unit of the graphics processor to the local storage of the neural network processor.

Thus, in an embodiment:
the processor configured to perform neural network processing comprises local storage that is used for storing data locally while an execution unit or units of the processor are performing neural network processing (and that is, in an embodiment, internal to the processor that is configured to perform neural network processing and that can be accessed by execution units of the processor that is configured to perform neural network processing directly without the need for any access to the memory system of the data processing system); and the graphics processor comprises local storage, such as, and in an embodiment, a set of registers, for storing data for use by the programmable execution unit of the graphics processor when executing a program;
and the method of the technology described herein comprises:
when the programmable execution unit of the graphics processor is to execute or is executing a program to perform a processing operation for neural network processing under the control of the control circuit of the processor configured to perform neural network processing:
loading data directly from the local storage of the processor configured to perform neural network processing to local storage of the graphics processor for use when the programmable execution unit of the graphics processor is executing the program to perform a processing operation for neural network processing; and/or
storing data generated by the execution of a program by the programmable execution unit of the graphics processor to perform a processing operation(s) for neural network processing directly from the local storage of the graphics processor to the local storage of the processor configured to perform neural network processing (in an embodiment for subsequent use by an execution unit of the processor configured to perform neural network processing).

In order to facilitate this operation, there are in an embodiment appropriate communications interfaces and control units as between the graphics processor and the neural processor. For example, and in an embodiment, the neural processor may include a “local storage” access unit that facilitates the transfer of data between the local storage of the neural processor and the local storage of the (programmable execution unit) of the graphics processor. Correspondingly, the processing core (execution core) that the programmable execution unit of the graphics processor is part of in an embodiment comprises an appropriate unit or units (circuits) that are operable to transfer data between the local storage of the graphics processor and the local storage of the neural processor.

To further facilitate this operation, when a processing operation or operations for neural network processing is to be performed by execution of a program by the programmable execution unit of the graphics processor, the appropriate input and output data structures (pipes) (buffers) within the shared storage of the neural processor that are to be used as input and output sources for the program execution are in an embodiment appropriately defined, and information indicating those input and output data structures (pipes) (buffers) is in an embodiment appropriately conveyed to the (control unit (thread group (warp) manager) of the) graphics processor.

This local storage input and output storage/buffer information may then be used by, and conveyed to, for example, and in an embodiment, an appropriate control unit for the local storage of the neural processor to record that information for the input and output buffers in the local storage, e.g., and in an embodiment, in association with an identifier for the block of processing (the processing task) that they relate to, such that that information can then be used to access the desired data in the input buffers in the local storage when required, and any output data can be written to the appropriate output buffer in the local storage when required.

The information describing any input and output buffers within the shared storage of the neural processor that are to be used as input and output sources for program execution on the graphics processor may, for example, and in an embodiment, indicate the buffer's offset, stride, layout, etc., as desired and required.

As discussed above, in an embodiment, the shared storage of the neural processor is configured as respective data structures (pipes), and in an embodiment as FIFO queues, which may then act as (be used as) input and/or output buffers within the shared storage of the neural processor that are to be used as input and output sources for program execution on the graphics processor. Thus, in an embodiment, the information describing any input and output buffers within the shared storage of the neural processor that are to be used as input and output sources for program execution on the graphics processor defines, inter alia, respective input and output pipes within the shared storage of the neural processors that are to be used as input and output sources for program execution on the graphics processor.

Correspondingly, in an embodiment, and as discussed above, the shader program execution on the graphics processor is performed for respective blocks of processing (work) that the overall processing operation (iteration) space has been divided into, with each block having a corresponding associated and specific buffer (entry) within a given pipe or pipes (FIFO queue or queues) that will be used as an input or output source of data when executing the shader program. Thus the shader program execution in an embodiment is performed in and for respective blocks of work, with each such block using its respective, and specific, buffers in the relevant pipes/FIFOs in the local storage of the neural processor that are to be used as input and/or output sources for the program execution.

Correspondingly, any addressing for data that is used in the shader program execution is in an embodiment configured and set to be relative to the relevant block buffer in the pipe (queue) in question in the local storage, such that the same shader program can be reused for every block and the addressing is always contained/relative to and within a respective block (such that there is no need to change the addressing for different blocks that are each to execute the shader program in question). For example, and in an embodiment, a read (or write) to a given address during shader program execution should, and in an embodiment does, always relate to the same relative address within the buffer in question (although the buffer will be specific to the block in question). Thus, for example, a read from address 0 will always relate to the beginning of the buffer for the block in question in the pipe (queue) in question.

In such embodiments, in an embodiment, the graphics processor (execution core) can, and in an embodiment does, accordingly communicate when it requires data to be written to or read from the local storage of the neural processor, and in an embodiment conveys appropriately to the neural processor the relative addresses that it wants to access and which block of work the access relates to (it is executing) and which set of data in the local storage (which pipe/queue) it wants to access.

As will be discussed further below, the neural processor in an embodiment includes an appropriate control unit(s) (circuit(s)) for its local storage that is operable to and configured to convert this information in a “request” from the graphics processor into the appropriate (real) address for the local storage of the neural processor, for example, and in an embodiment based on which neural network processing operation (shader program) is being executed, the block of work that the program is being executed for and that the request relates to, the pipe (queue) that is being accessed, and the relative address within the block of work that the access is for. The appropriate control unit(s) on the neural processor may then operate to identify the relevant buffer to be accessed in the local storage of the neural processor and then do the relative addressing to find the actual (real) address in the local storage of the neural processor to be accessed.

Data may be transferred between the local storage of the neural processor and the local storage for the programmable execution unit of the graphics processor when executing a program to perform processing for neural network processing in the manner of the technology described herein in any suitable and desired manner.

In one embodiment, the transfer of (input) data from the local storage of the neural engine to the (local storage of the) graphics processor is achieved by loading data from the local storage of the neural processor (directly) to appropriate local storage, such as and in an embodiment, the relevant registers, for the programmable execution unit of the graphics processor before execution of the program to perform the operation or operations for the neural network processing is begun (e.g. for a respective thread group).

This is in an embodiment done by means of an appropriate “pre-load” operation that loads data from the local storage of the neural processor to the local storage of the graphics processor before the program execution, e.g. for a thread group, is begun.

This is in an embodiment done on a thread group (warp)-by-thread group (warp) basis, i.e. such that for each thread group that is to execute the program to perform the processing operation(s) for the neural network processing, the appropriate input data is loaded from the local storage of the neural processor to the appropriate set of registers for the thread group in question, before the program execution for the thread group is begun.

In this case therefore, the data required by a thread group when executing the program will, in effect, be “pre-loaded” into local storage, such as the register file of the execution core of the graphics processor, from the local storage of the neural processor, before the thread group executes the program.

In an embodiment, any and all data required from the local storage of the neural processor for the program execution for a given thread group (warp) is loaded into the local storage, e.g. register file, of the programmable execution unit (execution core) of the graphics processor (in advance), such that no further data will be required from the local storage of the neural processor when executing the (shader) program for the thread group in question.

Correspondingly, in one embodiment, the transfer of (output) data from the local storage of the graphics processor to the local storage of the neural processor is achieved by writing data from the local storage, such as and in an embodiment, the relevant registers, for the programmable execution unit of the graphics processor that has executed the program to perform the processing operation(s) for the neural network processing (directly) to the local storage of the neural processor after execution of the program to perform the operation or operations for the neural network processing has been completed (e.g. for a respective thread group).

This is in an embodiment done by means of an appropriate “post-store” operation that writes data from the local storage of the graphics processor to the local storage of the neural processor after the program execution, e.g. for a thread group, has finished.

This is again in an embodiment done on a thread group (warp)-by-thread group (warp) basis, i.e. such that for each thread group that executes the program to perform the processing operation(s) for the neural network processing, the appropriate output data is written from the appropriate set of registers for the thread group in question to the local storage of the neural processor after the thread group has finished its execution.

In this case therefore, output data generated by a thread group when executing the program will, in effect, be “post-stored” into the local storage of the neural processor, from the local storage, such as the register file, of the programmable execution unit (execution core) of the graphics processor, after the thread group has finished executing the program.

In an embodiment, any and all (output) data generated by the program execution for a given thread group (warp) that is to be stored into the local storage of the neural processor is so-stored after the program execution for the thread group is completed (finished), such that no (output) data will be written to the local storage of the neural processor during execution of the (shader) program for the thread group in question.

In order to facilitate such operation, the (execution core of the) graphics processor in an embodiment includes an appropriate register pre-load/post-store unit (circuit) that is operable to and configured to transfer data (directly) between the local storage of the neural processor and the local storage (register file) of the graphics processor. In an embodiment this register pre-load/post-store unit has an appropriate (direct) interface to a, e.g. control unit for, such as, and in an embodiment a local storage access unit of, the local storage of the neural processor for this purpose.

In order to facilitate such (register) pre-load and post-store operations for thread groups, in an embodiment appropriate information is provided, e.g. from the control unit (thread group manager) of the graphics processor, e.g. to the register pre-load/post-store unit, indicating for example, and in an embodiment, in the case of a pre-load operation, the identity of the work block for which the pre-load needs to take place, for which thread group (warp) the pre-load is being performed, the registers into which data should be pre-loaded from the local storage of the neural processor, and/or an appropriate mapping to indicate which data in the local storage of the neural processor should be loaded in to which register.

Correspondingly, in the case of a “post-store” operation, information, indicating for example, and in an embodiment, the identity of the work block that the post-store relates to, for which thread group (warp) the post-store is being performed, the registers from which data should be post-stored in the local storage of the neural processor, and/or an appropriate mapping to indicate where the data in a given register should be stored in the local storage of the neural processor, is in an embodiment provided.

In an embodiment, the transfer of (input) data from the local storage of the neural processor to the (local storage of the) graphics processor can be, and is, achieved by loading data from the local storage of the neural processor (directly) to appropriate local storage, such as and in an embodiment, the relevant registers, for the programmable execution unit of the graphics processor, during execution of the program to perform the operation or operations for the neural network processing (for a respective thread group).

This is in an embodiment done by including an appropriate “neural processor local storage” load instruction in the program being executed to perform the operation or operations for the neural network processing, that when executed triggers the loading of data from the local storage of the neural processor to the local storage of the graphics processor.

Thus, in an embodiment, data can be (and is) loaded (directly) from the local storage of the neural processor to local storage (such as and in an embodiment a set of registers), for the programmable execution unit of the graphics processor for use when executing a program to perform processing operations for neural network processing in response to execution of a (particular) instruction in the program that is being executed to perform the processing operation(s) for the neural network processing.

Thus, in an embodiment, a program to be executed to perform operations for neural network processing can include an instruction that when executed will cause data to be loaded from the local storage of the neural processor to local storage for, such as, and in an embodiment, an appropriate register or registers of, the programmable execution unit that is executing the program.

This will then allow the program execution itself to be used to control and trigger the loading of data from the local storage of the neural processor to the local storage of the graphics processor.

Thus, in an embodiment:
the processor configured to perform neural network processing comprises local storage that is used for storing data locally while an execution unit or units of the processor are performing neural network processing (and that is, in an embodiment, internal to the processor that is configured to perform neural network processing and that can be accessed by execution units of the processor that is configured to perform neural network processing directly without the need for any access to the memory system of the data processing system); and
the graphics processor comprises local storage, such as, and in an embodiment, a set of registers, for storing data for use by the programmable execution unit of the graphics processor when executing a program;
and the method of the technology described herein comprises:
when the programmable execution unit of the graphics processor is executing a program to perform a processing operation for performing neural network processing, the programmable execution unit in response to an instruction in the program being executed, causing data to be loaded from the local storage of the processor that is configured to perform neural network processing to local storage for the programmable execution unit for use when executing the program to perform the processing operation(s) for neural network processing.

Correspondingly, the programmable execution unit of the graphics processor in an embodiment is configured to, in response to an instruction in a program being executed by the programmable execution unit that indicates that data should be loaded from local storage of a processor configured to perform neural network processing to local storage for the programmable execution unit, cause data to be loaded from local storage of the processor configured to perform neural network processing to the local storage for the programmable execution unit.

The load instruction is in an embodiment appropriately identifiable as being a load instruction that is to load data from the local storage of the neural processor. The load instruction may, for example, be explicitly indicated as being such a load instruction, or it may be indirectly identifiable as such, for example by indicating an address to be loaded from that maps to the local storage of the neural processor (rather than to the memory system of the data processing system) when the appropriate address mapping is applied. For example, an appropriate addressing mode could be indicated for such instructions.

The load instruction in an embodiment also indicates and provides any further information required for the loading of the data from the local storage of the neural processor, such as which set of data (buffer) is to be accessed, the “entry” (location) in the buffer that is to be loaded, and the register or registers where the loaded data is to be stored. As discussed above, in an embodiment, the set of data to be accessed is in an embodiment indicated in terms of a relevant pipe (queue) that is to be accessed, and the “entry” (location) in that pipe that is to be loaded is in an embodiment indicated in terms of a relative address within the buffer in question.

Correspondingly, in an embodiment, the transfer of (output) data from the local storage of the graphics processor to the local storage of the neural processor can be, and is, achieved by writing data from the local storage, such as and in an embodiment, the relevant registers, for the programmable execution unit of the graphics processor that is executing the program to perform the processing operation(s) for the neural network processing, (directly) to the local storage of the neural processor during execution of the program to perform the operation or operations for the neural network processing (for a respective thread group).

This is in an embodiment done by including an appropriate “neural processor local storage” store instruction in the program being executed to perform the operation or operations for the neural network processing, that when executed triggers the writing of data from the local storage of the graphics processor to the local storage of the neural processor.

Thus, in an embodiment, data can be (and is) written (directly) into the local storage of the neural processor from local storage (such as and in an embodiment a set of registers) for the programmable execution unit of the graphics processor in response to execution of a (particular) instruction in the program that is being executed to perform the processing operation(s) for the neural network processing.

Thus, in an embodiment, a program to be executed to perform operations for neural network processing can include an instruction that when executed will cause data to be stored into the local storage of the neural processor from local storage for, such as, and in an embodiment, an appropriate register or registers of, the programmable execution unit that is executing the program.

This will then allow the program execution itself to be used to control and trigger the storing of data into the local storage of the neural processor from the local storage of the graphics processor.

Thus, in an embodiment:
the processor configured to perform neural network processing comprises local storage that is used for storing data locally while an execution unit or units of the processor are performing neural network processing (and that is, in an embodiment, internal to the processor that is configured to perform neural network processing and that can be accessed by execution units of the processor that is configured to perform neural network processing directly without the need for any access to the memory system of the data processing system); and
the graphics processor comprises local storage, such as, and in an embodiment, a set of registers, for storing data for use by the programmable execution unit of the graphics processor when executing a program;
and the method of the technology described herein comprises:
when the programmable execution unit of the graphics processor is executing a program to perform a processing operation for performing neural network processing, the programmable execution unit in response to an instruction in the program being executed, causing data to be written from the local storage for the programmable execution unit into the local storage of the processor that is configured to perform neural network processing, e.g., and in an embodiment, for use then by an execution unit of the processor configured to perform neural network processing.

Correspondingly, the programmable execution unit of the graphics processor in an embodiment is configured to, in response to an instruction in a program being executed by the programmable execution unit that indicates that data should be stored into local storage of a processor configured to perform neural network processing from local storage for the programmable execution unit, cause data to be stored into local storage for the processor configured to perform neural network processing from the local storage of the programmable execution unit.

The store instruction is in an embodiment appropriately identifiable as being a store instruction that is to store data into the local storage of the neural processor. The store instruction may, for example, be explicitly indicated as being such a store instruction, or it may be indirectly identifiable as such, for example by indicating an address to be written to that maps to the local storage of the neural processor (rather than to the memory system of the data processing system) when the appropriate address mapping is applied. For example, an appropriate addressing mode could be indicated for such instructions.

The store instruction in an embodiment also indicates and provides any further information required for the storing of the data into the local storage of the neural processor, such as which set of data (buffer) is to be written to, the “entry” (location) in the buffer that is to be written, and the register or registers whose content is to be written to the local storage of the neural processor. As discussed above, in an embodiment, the set of data to be accessed is in an embodiment indicated in terms of a relevant pipe (queue) that is to be accessed, and the “entry” (location) in that pipe that is to be written to is in an embodiment indicated in terms of a relative address within the buffer in question.

In an embodiment, such load and store instructions are implemented by means of a load/store unit of the execution core of the graphics processor which in the normal course would load and store data to the memory system of the data processing system, but which is configured to, in response to such load and store instructions, instead load data from or store data to the local storage of the neural processor. The load/store unit correspondingly accordingly in an embodiment has an appropriate interface to access the local storage of the neural processor that is, e.g., and in an embodiment, independent of, and does not require the use of, any bus interface or otherwise to the memory system of the data processing system.

In this case therefore, the load/store unit will have both an interface to the memory system of the data processing system, and a separate, different, interface to access the local storage of the neural processor.

Thus, in an embodiment, the graphics processor further comprises a load/store circuit having an interface to the memory system of the data processing system whereby it may transfer data between local storage for the programmable execution unit of the graphics processor and a memory system of the data processing system, and a separate interface with the processor that is configured to perform the neural network processing whereby it may transfer data between local storage of the processor that is configured to perform neural network processing and local storage for the programmable execution unit of the graphics processor.

In the case of accessing the local storage of the neural processor, the load/store unit in an embodiment communicates with and interfaces with an appropriate control circuit (control unit) (local storage access unit) for the local storage of the processor that is configured to perform the neural network processing (as discussed above), to thereby allow appropriate access and data transfer to and from the local storage of the neural processor.

In such an arrangement, the programmable execution unit of the graphics processor when it executes a neural processor load or store instruction, in an embodiment signals the load/store unit appropriately, to trigger and cause the load/store unit to load or store the relevant data from or to the local storage of the neural processor. There is accordingly in an embodiment a corresponding communications interface from the programmable execution unit to the load/store unit, via which such load and store operations can be triggered.

When communicating with the appropriate control unit (circuit) for the local storage of the processor that is configured to perform neural processing, the load/store unit of the graphics processor's execution core in an embodiment conveys appropriate information to allow the required data in the local storage of the neural processor to be identified (in the case of a load instruction) and/or the relevant entry in the local storage of the neural processor where the data is to be stored to be identified (in the case of a store instruction).

Thus, in the case of a load instruction, in an embodiment the load store unit conveys to the neural processor (and in an embodiment to a control circuit for the local storage of the neural processor), any and all information required for the loading of the data from the local storage of the neural processor, such as, and in an embodiment, an appropriate identity of the block of work for which the load is being issued, which set of data (pipe) (buffer) in the local storage for that block of work the data is to be loaded from, and the (relative) element (location) in the buffer that is to be loaded.

Correspondingly, in the case of a store instruction the information in an embodiment comprises an appropriate identity of the block of work for which the store is being issued, which set of data (pipe) (buffer) in the local storage for that block of work the data is to be stored in, the (relative) element (location) in the buffer that is to be written to, and the value being stored into the local storage.

It is believed that the provision of instructions in a (shader) program to be executed by a programmable execution unit of a graphics processor that will cause data to be loaded from or stored to local storage of an associated neural processor may be new and advantageous in its own right.

Thus, another embodiment of the technology described herein comprises a method of generating a program for execution by a programmable execution unit of a graphics processor to perform a processing operation or operations for neural network processing, the method comprising:
including in a program to be executed by the programmable execution unit of the graphics processor to perform a processing operation or operations for neural network processing, at least one of:
an instruction that when executed will trigger the loading of data for use when executing the program to perform a processing operation or operations for neural network processing from local storage of a processor configured to perform neural network processing to local storage for the programmable execution unit of the graphics processor for use when executing the program to perform a processing operation or operations for neural network processing; and
an instruction that when executed will cause data stored in local storage for the programmable execution unit of the graphics processor to be written to local storage of a processor configured to perform neural network processing (and in an embodiment for use by an execution unit of the processor configured to perform neural network processing when performing a processing operation for neural network processing).

Another embodiment of the technology described herein comprises an apparatus for generating a program for execution by a programmable execution unit of a graphics processor to perform a processing operation or operations for neural network processing, the apparatus comprising one or more processing circuits configured to:
include in a program to be executed by a programmable execution unit of a graphics processor to perform a processing operation or operations for neural network processing, at least one of:
an instruction that when executed will trigger the loading of data for use when executing the program to perform a processing operation or operations for neural network processing from local storage of a processor configured to perform neural network processing to local storage for the programmable execution unit of the graphics processor for use when executing the program to perform a processing operation or operations for neural network processing; and
an instruction that when executed will cause data stored in local storage for the programmable execution unit of the graphics processor to be written to local storage of a processor configured to perform neural network processing (and in an embodiment for use by an execution unit of the processor configured to perform neural network processing when performing a processing operation for neural network processing).

Correspondingly, the technology described herein also extends to a graphics processor including a programmable execution unit that is configured to use such load and store instructions.

Thus, a further embodiment of the technology described herein comprises a method of operating a graphics processor, the graphics processor comprising a programmable execution unit operable to execute processing programs to perform processing operations and local storage configured to store data for use by the programmable execution unit of the graphics processor when executing a program;
the method comprising:
in response to an instruction in a program being executed by the programmable execution unit, loading data from local storage of a processor configured to perform neural network processing to the local storage of the graphics processor for use by the programmable execution unit of the graphics processor when executing further instructions in the program being executed; and/or
in response to an instruction in a program being executed by the programmable execution unit of the graphics processor, writing data stored in the local storage for the programmable execution unit of the graphics processor during execution of the program by the programmable execution unit of the graphics processor to local storage of a processor configured to perform neural network processing (for use by an execution unit or units of the processor configured to perform neural network processing).

A further embodiment of the technology described herein comprises a graphics processor, the graphics processor comprising:
a programmable execution unit operable to execute processing programs to perform processing operations; and
local storage configured to store data for use by the programmable execution unit of the graphics processor when executing a program;
wherein:
the programmable execution unit is configured to:
in response to an instruction in a program being executed by the programmable execution unit, cause data to be loaded from local storage of a processor configured to perform neural network processing to the local storage of the graphics processor for use by the programmable execution unit of the graphics processor when executing further instructions in the program being executed; and/or
in response to an instruction in a program being executed by the programmable execution unit, cause data stored in the local storage for the programmable execution unit of the graphics processor during execution of the program by the programmable execution unit of the graphics processor to be written to local storage of a processor configured to perform neural network processing (for use by an execution unit or units of the processor configured to perform neural network processing).

As will be appreciated by those skilled in the art, all of these embodiments of the technology described herein may, and in an embodiment do, comprise any one or more or all of the optional features of the technology described herein described herein. Thus the local storage of the graphics processor and of the neural processor are in an embodiment as discussed above, and the appropriate load and store instructions are in an embodiment as discussed above.

Such load and store instructions can be included in a (shader) program for execution by a programmable execution unit of a graphics processor in any suitable and desired manner. In an embodiment this is done as part of an (overall) neural network processing (shader) program “compilation” process, where, for example, and in an embodiment, a lower level executable sequence of program instructions for performing a processing operation or operations for neural network processing is generated.

Thus, the load and store instructions may be, and are in an embodiment, included in a program for execution by a programmable execution unit of a graphics processor by means of a suitable compilation process that generates the program instructions for execution by the programmable execution unit of the graphics processor, e.g., and in an embodiment, from a suitable higher level description of the operations that the program is to perform.

Thus, a higher level description of the neural network processing operations to be performed by execution of the (shader) program is in an embodiment compiled into an appropriate “lower level” set of executable instructions for the programmable execution unit of the graphics processor, that can then be appropriately executed by the graphics processor to perform the required operations for the neural network processing.

Thus, the preparation of the program to be executed by the graphics processor to perform the processing operations for the neural network processing is in an embodiment done by a compiler for the graphics processor, which compiler may, e.g., and in an embodiment, be executed on an appropriate processor (e.g. CPU) of a data processing system (e.g. of the data processing system that the graphics processor and neural processor are a part of, or of a separate data processing system, as desired).

The compilation process may be, and is in an embodiment, performed in advance of any execution and performing of the neural network processing itself, in an “offline” manner. Thus (at least some of) the compilation process is in an embodiment done in advance of runtime, rather than at runtime for the neural network processing in question. Correspondingly (at least some of) the compilation process and compiler in an embodiment executes separately in advance of running the driver (the driver operation for performing the neural network processing).

Thus, in an embodiment, a compiler operation will prepare in advance suitable programs for execution by the graphics processor to perform processing operations for neural network processing, including any load and store instructions in the manner of the present embodiments, as required, and then, for example, and in an embodiment, store those programs (sets of instructions) for future use. For example, as discussed above, a suitable set (library) of (shader) programs for performing processing operations for neural network processing is in an embodiment generated and stored in advance, from which a given (shader) program or programs to be executed for particular neural network processing can then be selected and used.

In an embodiment, the compiling and compilation process, when generating a program for execution by a graphics processor for performing processing operations for neural network processing comprises for a (and in an embodiment for each) processing operation to be perform for the neural network processing by the program to be executed by the programmable execution unit of the graphics processor, determining whether the operation requires an input from an (the) associated processor configured to perform neural network processing, and when it is determined that the processing operation requires an input from an associated processor configured to perform neural network processing, including in the program to be executed by the programmable execution unit of the graphics processor before instructions for the processing operation, an instruction that when executed will cause the loading of data from local storage of the processor configured to perform neural network processing to local storage for the programmable execution unit of the graphics processor; and/or determining whether data generated by a processing operation performed by execution of instructions in the program to be executed by the programmable execution unit of the graphics processor will be required by an execution unit of an associated processor configured to perform neural network processing; and when it is determined that data generated by a processing operation performed by execution of instructions in the program will be required for an execution unit of the associated processor configured to perform neural network processing, including after the instructions that execute the processing operation, an instruction that when executed will cause data to be written from local storage for the programmable execution unit of the graphics processor to local storage of an associated processor configured to perform neural network processing.

This may be, and is in an embodiment, repeated, for each operation that is performed by executing instructions in the program in question.

The technology described herein extends to such generation of programs for execution to perform processing operation(s) for neural network.

Thus, another embodiment of the technology described herein comprises a method of generating from a higher level description of neural network processing operation(s) to be performed, a set of program instructions that when executed by a programmable execution unit of a graphics processor will perform the neural network processing operation(s);
the method comprising:
for a processing operation to be performed for the neural network processing indicated by the higher level description of the neural network processing operation(s) to be performed:
determining whether the operation requires an input from an associated processor configured to perform neural network processing; and
when it is determined that the processing operation requires an input from an associated processor configured to perform neural network processing, including in the program to be executed by the programmable execution unit of the graphics processor before instructions for the processing operation, an instruction that when executed will cause the loading of data from local storage of the processor configured to perform neural network processing to local storage for the programmable execution unit of the graphics processor;
and/or
determining whether data generated by a processing operation performed by execution of instructions in the program to be executed by the programmable execution unit of the graphics processor will be required by an execution unit of an associated processor configured to perform neural network processing; and
when it is determined that data generated by a processing operation performed by execution of instructions in the program will be required for an execution unit of the associated processor configured to perform neural network processing, including after the instructions that execute the processing operation, an instruction that when executed will cause data to be written from local storage for the programmable execution unit of the graphics processor to local storage of an associated processor configured to perform neural network processing.

Another embodiment of the technology described herein comprises an apparatus for generating from a higher level description of neural network processing operation(s) to be performed, a set of program instructions that when executed by a programmable execution unit of a graphics processor will perform the neural network processing operation(s);
the apparatus comprising processing circuits configured to:
for a processing operation to be performed for the neural network processing indicated by the higher level description of the neural network processing operation(s) to be performed:
determine whether the operation requires an input from an (the) associated processor configured to perform neural network processing; and
when it is determined that the processing operation requires an input from an associated processor configured to perform neural network processing, include in the program to be executed by the programmable execution unit of the graphics processor before instructions for the processing operation, an instruction that when executed will cause the loading of data from local storage of the processor configured to perform neural network processing to local storage for the programmable execution unit of the graphics processor;
and/or
determine whether data generated by a processing operation performed by execution of instructions in the program to be executed by the programmable execution unit of the graphics processor will be required by an execution unit of an associated processor configured to perform neural network processing; and
when it is determined that data generated by a processing operation performed by execution of instructions in the program will be required for an execution unit of the associated processor configured to perform neural network processing, include after the instructions that execute the processing operation, an instruction that when executed will cause data to be written from local storage for the programmable execution unit of the graphics processor to local storage of an associated processor configured to perform neural network processing.

As will be appreciated by those skilled in the art, these embodiments of the technology described herein can and in an embodiment do include any one or more or all of the optional features of the technology described herein described herein, as appropriate.

In these embodiments of the technology described herein, it can be determined whether an operation for neural network processing to be performed by the program execution will require the loading or storing of data from or to the local storage of an associated processor configured to perform neural network processing in any suitable and desired manner. For example, it may be possible for the higher level (e.g. programmer's) description of the processing to be performed to be such that that higher level description can indicate directly processing operations that are to use data loaded from local storage of an associated neural network processor and/or whose outputs are to be written to local storage of an associated neural processor.

Additionally or alternatively, the (shader) program compilation process can be configured to be able to, and to operate to, itself identify processing operations that require data from an associated processor configured to perform neural network processing, and/or whose outputs are to be provided to an associated processor configured to perform neural network processing, and to then include appropriate load and/or store instructions in the compiled program to be executed accordingly.

It will be appreciated in this regard that a given program for execution by a programmable execution unit of a graphics processor to perform processing operations for neural network processing under the control of an associated processor configured to perform neural network processing may include zero, one or plural such load instructions and, correspondingly, zero, one or plural such store instructions, for example, and in an embodiment, in dependence upon the particular processing operations and the input data required for those processing operations to be performed by executing the program, and the output data generated by those processing operations.

Other arrangements would, of course, be possible.

It would be possible for the operation in the manner of the technology described herein to include both a pre-load/post-store operation(s) as discussed above, and the execution of program instructions in the manner discussed to load/store further data from or to the local storage of the neural processor (and in one embodiment that is what is done).

In an embodiment, data is transferred to and from the local storage of the neural processor solely by the execution of appropriate instructions when executing the program to perform the processing operation(s) for the neural network processor (i.e. without there also being any pre-load or post-store operation as discussed above). In this case, any and all data will accordingly be transferred between the local storage of the graphics processor and the local storage of the neural processor in response to and under the control of instructions in the program that is being executed to perform the processing operation(s) for the neural network processing.

It will be appreciated that when performing neural network processing in the manner of the technology described herein, there may be a need to only execute a single program to perform processing operations for the neural network processing, or there may be multiple instances of program execution to perform processing operations for the neural network processing that are performed by the programmable execution unit of the graphics processor. Correspondingly, there may accordingly be processing operations that are performed by the execution of a program by the graphics processor interleaved with other processing operations for the neural network processing that are performed using execution units of the neural processor.

Thus, for example, and in an embodiment, a processing operation performed by an execution unit of the neural processor may be followed by the execution of a program to perform a processing operation for the neural network processing on a graphics processor, followed by a further processing operation or operations performed by execution units of the neural processor (and so on, as required).

This processing, and the scheduling of the processing on either the neural processor or the graphics processor will be performed under the control of the control circuit of the neural processor, in response to the indications of neural network processing to be performed that are provided.

It should accordingly correspondingly be noted in this regard that the operation of the graphics processor to execute a program to perform a processing operation for the neural network processing when operating in the manner of the technology described herein is (wholly and entirely) triggered by and under the control of the neural processor (and the control circuit/messaging/interface circuit of the neural processor). The appropriate control unit (e.g. the thread group (warp) manager) of the graphics processor when operation in the manner of the technology described herein is required should not, and in an embodiment does not, receive any control communications (messaging) in relation to the neural network processing from a source other than the neural processor (i.e. such that the operation in the manner of the technology described herein is controlled entirely by triggering the neural processor to perform the neural network processing and providing the appropriate indications of the neural network processing to be performed to the (control circuit of the) neural processor).

It should be noted in this regard that the shader program execution to perform processing operations for neural network processing in the manner of the technology described herein may be interleaved with shader program execution for performing other processing (such as graphics processing). Thus, for example, the shader execution core may interleave the execution of thread groups for performing processing operations for neural network processing (under the control of the neural processor) and the execution of thread groups for performing graphics processing (which will be executing a different shader program). However, any shader program execution for the purposes of performing processing operations for neural network processing in the manner of the technology described herein is triggered by, and controlled by, the neural processor.

As well as the processor configured to perform neural network processing and the graphics processor, the data processing system may otherwise comprise any desired components and elements that a data processing system can comprise, such as one or more or all of: a display processing unit (display processor), one or more central processing units (CPU), a video processor, a digital signal processor, a display and a memory.

The processors may be arranged within a system-on-chip system.

The data processing system may be implemented as part of any suitable electronic device which may be required to perform neural network processing, e.g., such as a desktop computer, a portable electronic device (e.g. a tablet or mobile phone), or other electronic device. Thus the technology described herein also extends to an electronic device that includes the data processing system of the technology described herein (and on which the data processing system operates in the manner of the technology described herein). The data processing system of the technology described herein may, in an embodiment, be implemented as part of a portable electronic device (such as a mobile phone, tablet, or other portable device).

The technology described herein may be used in conjunction with and for any suitable and desired neural network and neural network processing. In embodiments, the neural network is a convolutional neural network.

In embodiments, the neural network processing may relate to an “inferencing” or “classification” process. However, there are various different types or arrangements of neural networks that may be used to perform different operations, as desired, and the technology described herein may find utility in any suitable such applications. The technology described herein may also be used during a training process.

The input for the neural network processing may correspond to (or be derived from) any suitable data which is received by the data processing system for processing according to neural network processing in order to generate a useful output such as, for example, an image, an image from an Image Signal Processor (ISP), an image frame from video data, sound data or voice data, or other input data. Correspondingly the neural network processing which is to be performed may contribute to identifying or classifying features present within the data (initially) received by the data processing system, e.g. such as objects in an input image, or sound features in input sound data. Alternatively, the neural network processing which is to be performed may contribute to training the neural network.

The output of the neural network processing may be written to memory, or may be provided directly to a processor for use as an input, for example.

The data processing system may comprise and/or be in communication with one or more memories (such as the memories described above) that store the data described herein, and/or store software for performing the processes described herein. The data processing system may comprise and/or be in communication with a host microprocessor, and/or with a display for displaying output data associated with the neural network processing.

The data processing system of the technology described herein may be implemented as part of any suitable system, such as a suitably configured micro-processor based system. In some embodiments, the technology described herein is implemented in a computer and/or micro-processor based system.

The various functions of the technology described herein may be carried out in any desired and suitable manner. For example, the functions of the technology described herein may be implemented in hardware or software, as desired. Thus, for example, the various functional elements, units, etc., of the technology described herein may comprise a suitable processor or processors, controller or controllers, functional units, circuits, processing logic, microprocessor arrangements, etc., that are operable to perform the various functions, etc., such as appropriately dedicated hardware elements (processing circuits) and/or programmable hardware elements (processing circuits) that can be programmed to operate in the desired manner.

It should also be noted here that, as will be appreciated by those skilled in the art, the various functions, etc., of the technology described herein may be duplicated and/or carried out in parallel on a given processor. Equally, the various processing circuits may share processing circuits, etc., if desired.

It will also be appreciated by those skilled in the art that all of the described embodiments of the technology described herein may include, as appropriate, any one or more or all of the features described herein.

The methods in accordance with the technology described herein may be implemented at least partially using software e.g. computer programs. It will thus be seen that when viewed from further embodiments the technology described herein comprises computer software specifically adapted to carry out the methods herein described when installed on data processor, a computer program element comprising computer software code portions for performing the methods herein described when the program element is run on data processor, and a computer program comprising code adapted to perform all the steps of a method or of the methods herein described when the program is run on a data processing system.

The technology described herein also extends to a computer software carrier comprising such software which when used to operate a data processing system causes in a processor, or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

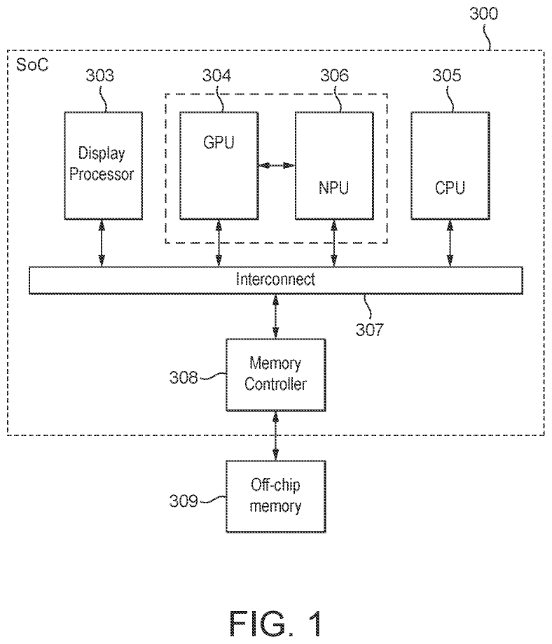

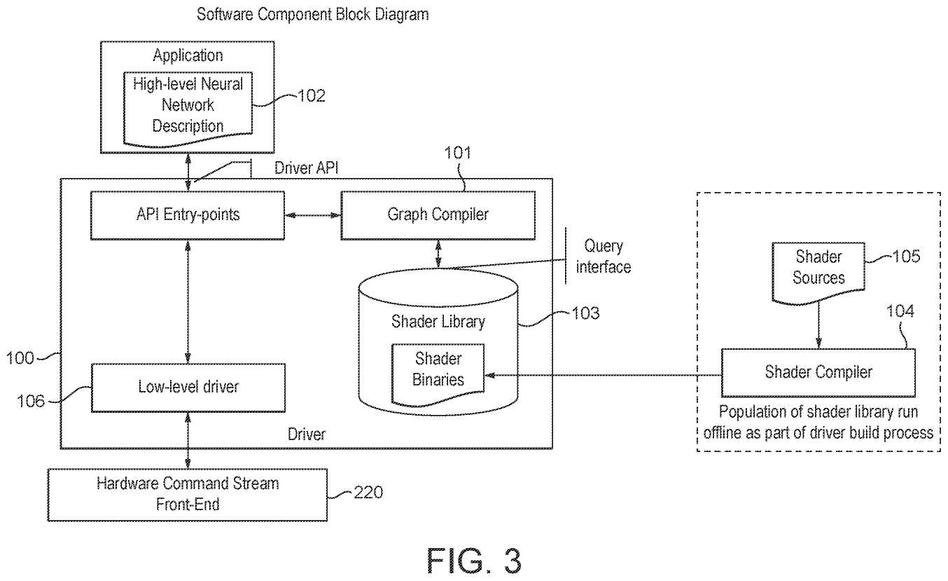

FIG. 1 shows an exemplary system on-chip (SoC) data processing system 300 within which the technology described herein can be employed. As shown in FIG. 1, the data processing system 300 in the present embodiment comprises a host processor in the form of a central processing unit (CPU) 305, a display processor 303, a graphics processor (GPU) 304 having an associated integrated neural network processing hardware accelerator (neural processing unit, NPU) 306, and a memory controller 308. As shown in FIG. 3, these units communicate via an interconnect 307 and have access to off-chip memory 309.

In this system, the graphics processor 304 will, for example, render frames (images) to be displayed, and the display processor 303 will then provide the frames for output, e.g. to a display panel for display.

Correspondingly, the neural network processing hardware accelerator (neural processing unit, NPU) 306 will perform neural network processing. The neural network processing hardware accelerator (neural processing unit, NPU) 306 comprises circuits (hardware) (e.g. such as multiply-accumulate circuits) which are specifically configured to more efficiently perform neural network processing. The neural network processing hardware accelerator (neural processing unit, NPU) 306 is thus designed to perform certain types of neural network processing operations in an optimised manner.

The data processing system 300 may of course include any other components or processing units that may be desired. For instance, the data processing system 300 may further comprise an image signal processor (ISP), a video decoder, an audio codec, etc., or any other components that a data processing system 300 may desirably have. A sensor may provide input data for the system 300 (e.g. video data and/or sound data from a suitable camera or microphone or other sensor device).

Likewise, the data processing system 300 need not contain all of the components or processing units illustrated in FIG. 3.

Furthermore, although FIG. 3 shows the neural network processing hardware accelerator (neural processing unit, NPU) 306 as integrated with (coupled to) the graphics processor 304 (and embodiments will accordingly be described in relation to the same), it will be appreciated that the processor (NPU) that is configured to perform the neural network processing could be a stand-alone unit instead, if desired.

As discussed above, the present embodiments relate in particular to the performing of neural network processing, using the neural processor 306 associated with the graphics processor 304, but in which the neural processor 306 can also trigger the execution of a program by the graphics processor 304 to perform processing operations for neural network processing that is being performed by the neural processor 306.

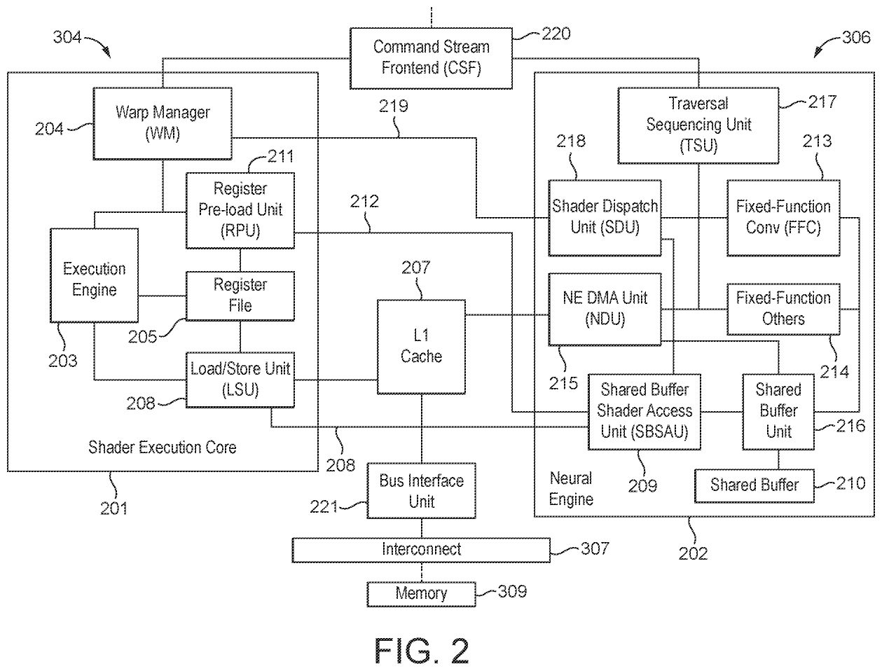

FIG. 2 shows in more detail the components and elements of the graphics processor 304 and neural processor 306, and the communications paths (interfaces) within and between the graphics processor 304 and the neural processor 306 that are used in particular when performing neural network processing in this manner.

(It will be appreciated in this regard that FIG. 2 shows those elements, units, communications paths, etc., that are particularly relevant to the operation in the manner of the present embodiments and the technology described herein. There may be other components, elements, communications paths, etc., that are not shown in FIG. 2, for example that may otherwise normally be present in a graphics processor and a neural network processor.)

FIG. 2 shows an exemplary shader execution core 201 of the graphics processor 304 having an associated neural processing unit in the form of a neural engine 202. The shader execution core and neural engine are, as shown, in FIG. 2, and as will be discussed further below, coupled to and integrated with each other, such that there is, for example, a number of direct communications paths (interfaces) between units of the shader execution core and of the neural engine 202, that are independent of any more general communication via the interconnect 307, for example. It will be appreciated that the graphics processor 304 may contain multiple shader execution cores, and any one or more or all of those shader execution cores may also have an associated neural engine, as desired.

As shown in FIG. 2, the shader execution core 201 of the graphics processor includes a programmable execution unit (engine) 203 that is operable to execute (instructions in) (shader) programs to perform processing operations. In the present embodiments, shader program execution is performed for respective groups (warps) of execution threads.

The shader execution core 201 correspondingly includes an appropriate control unit 204 in the form of a warp (thread group) manager that is operable to create (issue) groups (warps) of execution threads and manage their execution by the execution engine 203.

The shader execution core 204 further comprises appropriate local storage 205, in the form of a set of registers (a register file), for use for storing data locally to the execution engine 203 for use by and for execution threads when executing a program. The register file holds per-thread working registers, referenced by shader code.

There is also a load/store unit 206 that is operable to load data into the register file 205 and write data from the register file 205, e.g. and in an embodiment, in response to commands in that regard from the execution engine 203 (in response to program execution).

As shown in FIG. 2, the load store unit 206 has access to the main, off-chip memory 309 of the data processing system via an L1 cache 207 of the memory system cache hierarchy (which L1 cache 207 is shared, as shown in FIG. 2, with the neural engine 202).

The load/store unit 206 also has a direct communication path (interface) 208 to the neural engine 202 (to a shared buffer shader access unit 209 of the neural engine 202), whereby the load/store unit can load data directly from a local storage (shared buffer) 210 of the neural engine 202 to the register file 205 for use when the shader execution core is executing a program to perform neural network processing, and correspondingly can write data from the register file 205 directly to the local storage 210 of the neural engine that is generated when executing a program to perform neural network processing. This operation will be discussed in more detail below.

The shader execution core 201 also includes a register pre-load unit 211 that as shown in FIG. 2 also has a direct communication path (interface) 212 to the neural engine 202 (again to the shared buffer shader access unit 209 of the neural engine 202), whereby again data can be loaded from the local storage 210 of the neural engine directly to the register file 205 of the shader execution core, and stored from the register file 205 to the local storage 210 of the neural engine. Again, this operation will be discussed in more detail below.

As shown in FIG. 2, the neural engine 202 includes a number of fixed function execution units configured to perform particular processing operations for neural network processing, such as, in particular, a fixed function convolution unit 213 (that computes convolution-like arithmetic operations), and one or more other fixed function execution units 214 (e.g. that compute other arithmetic operations).

The neural engine also includes an appropriate direct memory access unit 215 via which it can transfer data between the memory system 309 of the data process system and the local storage, shared buffer 210 of the neural engine. Again this proceeds via the shared (common) L1 cache 207, as shown in FIG. 2.

As discussed above, the neural engine 202 also includes local storage 210, in the form of a “shared” buffer, that is operable to store locally to the neural engine 202 data (both input and output data) that is being used/generated by the fixed function units 213, 214 of the neural engine 202, when performing processing operations for neural network processing. The local storage, shared buffer 210 is accessed via an appropriate control unit in the form of a shared buffer unit 216 that arbitrates and controls access to the local storage, shared buffer 210.

The neural engine 202 includes a control unit, in the form of a traversal sequencing unit (TSU) 216, that is operable to distribute processing tasks to be performed by the execution units of the neural engine 202 to those execution units, in response to indications of neural network processing to be performed provided to the control unit (TSU) 217. The operation of the control unit (TSU) for the neural engine 202 will be discussed in more detail below.

As shown in FIG. 2, the neural engine 202 also includes a shader despatch unit 218 that acts as a (communications/messaging) interface between the neural engine 202 and the control unit (warp manager) 204 of the shader execution core 201.

As will be discussed in more detail below, the control unit (TSU) 217 of the neural engine 202 can cause the shader despatch unit 208 to communicate with the warp manager 204 to cause the execution by the shader execution core 201 of a program to perform processing operations for neural network processing that the neural engine 202 is performing. This operation again will be discussed in more detail below.

There is a direct communications interface 219 between the shader despatch unit 218 of the neural engine 202 and the warp manager 204 of the shader execution core 201 for this purpose.

As shown in FIG. 2, there is also a bus interface unit 221 that arbitrates access to the main interconnect 307 and path to memory.

In the present embodiments, the operation of the graphics processor 304 and the neural processor 306 (and in particular of the appropriate shader execution core and neural engine) is triggered and controlled by means of appropriate command streams that are generated and provided to the combined graphics processor and neural processing unit for execution. Such command streams will be generated, for example, and in an embodiment, by a driver on the host, CPU 305 in response to applications on the CPU requesting processing work that is to be performed by the graphics processor and/or neural processor, which command streams are then, for example, in an embodiment, stored appropriately so that they can then be retrieved and processed by the graphics processor and neural processor.

Thus, as shown in FIG. 2, there is a shared command stream front end (control unit) 220 that will process the command streams generated by the host, CPU 305, and in response to those command streams distribute appropriate processing jobs to the neural engine (and in particular to the control unit (TSU) 217 of the neural engine 202), or to the control unit (warp manager) 204 of the shader execution core, as appropriate. The command stream frontend 220 accordingly acts as an interface to the software driver and initiates work on the graphics processor 304 or neural processor 306, as appropriate. (In the case where the graphics processor has multiple shader execution cores some or all of which also have an associated neural engine, the command stream frontend will correspondingly distribute processing to and initiate work on the different shader cores, neural engines, etc., as desired.)

The appropriate control unit (either the TSU or warp manager) will then distribute processing tasks corresponding to the processing job conveyed by the command stream front end to the relevant execution units to perform those processing tasks.

In the present embodiments, in order to trigger the neural engine 202 to perform the appropriate sequence of processing operations for neural network processing that is required, an appropriate set of indications of the required neural network processing is provided to the control unit (TSU) 217 of the neural engine 202, with the control unit (TSU) 217 then operating in response to the indications of neural network processing required to distribute processing tasks relating to that processing to the fixed function execution units of the neural engine 202 or to the shader execution core 201 of the graphics processor 304 for program execution, appropriately.

Accordingly, for any given neural network processing that is required to be performed, an appropriate set or sets of indications of that processing to be performed for providing to the control unit (TSU) 217 of the neural engine 202 is generated, and, e.g., and in an embodiment, stored in the memory 309, from where they can subsequently be read by the control unit (TSU) 217 when the neural network processing in question is to be performed.

Correspondingly, a given command stream that is to trigger neural network processing will include an appropriate command to perform neural network processing, that will, e.g., and in an embodiment, identify the neural network processing (i.e. the sequence of indications of neural network processing that are to be read) that is to be performed.

Then, in response to such a “run neural network processing” command, the command stream frontend 220 will signal an appropriate neural network processing job to the control unit (TSU) 217 of the neural engine 202, including an indication of which set of neural network processing indications should be used to perform the neural network processing. The control unit (TSU) 217 will then read the appropriate set of neural network processing indications from the memory 309, and in response to those indications trigger the appropriate processing tasks on the fixed function execution units of the neural engine 202 and/or appropriate program execution on the shader execution core 201, as appropriate.

Correspondingly, where a processing operation or operations for neural network processing is to be performed by executing a shader program to perform those operations in the shader execution core 201 of the graphics processor 304, there will need to be a corresponding executable shader program defined and prepared for that purpose. Accordingly, the data processing system will also include a set (a library) of suitable shader programs each configured to perform respective processing operation(s) for neural network processing, such that an appropriate shader program for performing desired processing operations (that cannot otherwise be performed by the fixed function execution units of the neural engine 202) can be identified and selected for use when performing given neural network processing.

FIG. 3 illustrates this, and shows in particular that an overall driver process 100 for the neural processor (NPU) 306 will include, inter alia, a graph compiler 101 that is operable to convert a higher level, e.g. graph-based, description 102 of a neural network (e.g. that is used by an application) to an appropriate set of neural network processing indications for providing to the control unit (TSU) 217 of the neural engine 202.

The graph compiler 101 may execute, for example, on the CPU 305 (e.g. as part of the driver operation for the neural network processing hardware accelerator (neural processing unit, NPU) 306) of the overall data processing system. Additionally or alternatively, the compilation process may be performed “offline”, for example on a separate processor and data processing system to the system that includes the neural network processing hardware accelerator (neural processing unit, NPU) 306, with the compiled sequence of indications for the neural network then being stored appropriately in a memory for subsequent use by the neural network processing hardware accelerator (neural processing unit, NPU) 306 when the neural network processing is required.

As part of its operation, the graph compiler 101 may query and identify appropriate shader programs for performing neural network processing operations that are not supported by a fixed function execution unit of the neural engine 202 from a library 103 of previously generated such shader programs.

As shown in FIG. 3, there may be a separate (offline) shader compilation process 104 that generates appropriate executable shader programs (shader binaries) for the shader library 103 from higher level shader sources 105 that are written to perform the different forms of processing operation that may be required for neural network processing.

Any associated data structures for the neural network processing may also be generated and stored, e.g. in an offline manner, or at runtime, as appropriate.

The NPU 306 can then be caused to perform the neural network processing on-demand for applications executing on the host processor (CPU) 305. For example, an application executing on the host processor (CPU) 305 may request neural network processing.

A “lower level” driver part 106 of the overall driver 100 (e.g. executing on the CPU 305) will then identify (and/or generate (some of) the compiled set of neural network processing indications and any associated data structures for the neural network that is requested to be executed, and generate an appropriate command stream for sending to the command stream frontend 220 of the graphics processor 304 and neural processor 306, indicating that neural network processing is required and identifying the neural network to the executed, to thereby cause the required neural network to be performed.

Then, at runtime, in response to a request for neural network processing, the NPU 306 can load the appropriate set of indications to perform the desired neural network processing, and the NPU 306 will then work its way through the sequence of indications to cause the NPU hardware and/or graphics processor to perform the neural network processing. The result of the neural network processing can then be returned appropriately, e.g. written out to (external, e.g. main) memory, e.g. for use by the application requiring the neural network processing.

The present embodiments relate in particular to the situation where a neural network to be executed includes a processing operation or operations that is not supported (that cannot be performed) by a fixed function execution unit of the neural engine 202. In this case, the unsupported processing operation(s) are instead performed by shader program execution in the shader execution core 201.

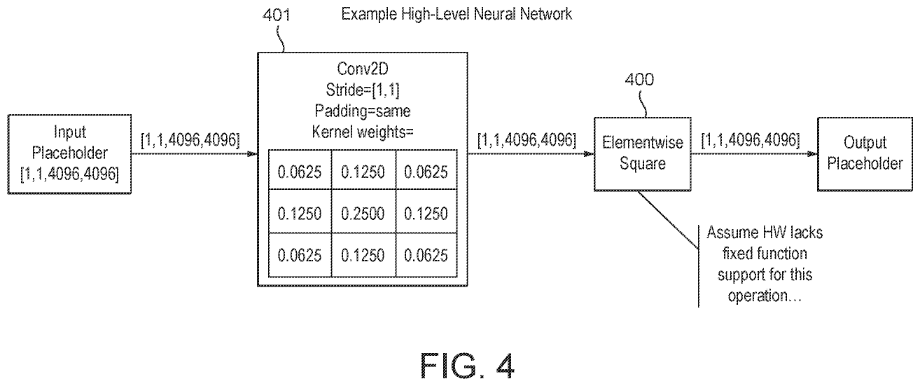

FIG. 4 shows an exemplary higher level neural network that includes an operation (in this case an elementwise square operation) 400 that it is assumed cannot be performed by a fixed function execution unit of the neural engine 202. Thus for the example neural network shown in FIG. 4, that elementwise square operation 400 will be performed by means of shader program execution on the shader execution core 201.

FIG. 4 also shows a 2D convolution operation 401 that can be performed by the fixed function convolution unit 213 of the neural engine 202, and so that will be performed by that fixed function convolution unit 213, and not by shader program execution.

It will be appreciated that the neural network shown in FIG. 4 is merely a simple example to illustrate the operation in the present embodiments. Various other arrangements would of course be possible. Further, a typical neural network model will of course contain many more processing operations, e.g. depending on the neural network in question.

As discussed above, this exemplary neural network shown in FIG. 4 will be represented by means of an appropriate set of neural network processing indications that are provided to the TSU 217 to thereby cause the neural network to be executed.

In the present embodiments, the indications of neural network processing to be performed are provided as a sequence of one or more “neural engine” descriptors (NEDs), each of which define, inter alia, a sequence of processing operations to be performed (referred to as “sections”). The corresponding inputs to and/or outputs from the operations are defined with reference to respective sets of data (buffers) stored in the shared buffer 210 of the neural engine 202, and are defined in the neural engine descriptors as “pipes” linking the operation “sections” (i.e. such that a given pipe may, for example, take an output from one operation (section) that will then act as an input to a next operation (section)).

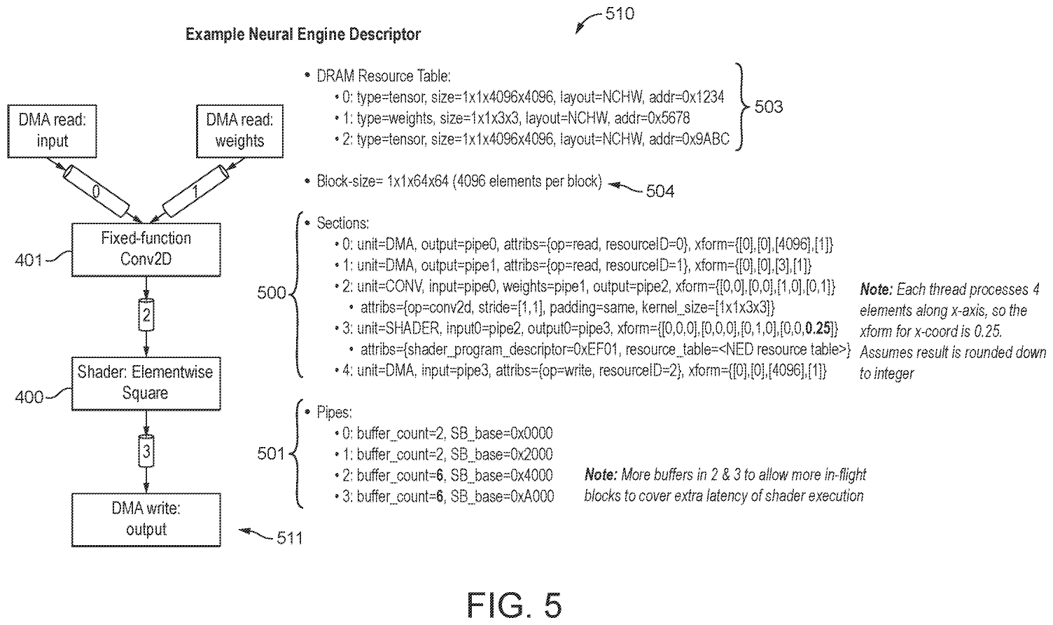

FIG. 5 shows the neural engine descriptor 510 and the corresponding visual representation 511 of the neural network processing for the exemplary high level neural network shown in FIG. 4.

Thus, as shown in FIG. 5, the neural engine descriptor for the high level neural network shown in FIG. 4 will include a sequence 500 of “sections” (operations) defining the sequence of operations that are to be performed for the neural network shown in FIG. 4, and a set of pipes 501 to be used linking those operations and where respective input data for an operation is to be read from or output data for an operation is to be written to.

In the present embodiments, and as is discussed above, the local storage of the neural processor is managed and configured as a set (series) of programmatically definable/configurable data structures (“pipes”), in the form of first-in first-out (FIFO) queues.

Each such pipe in the local storage may act as an input pipe for a given neural network processing operation and/or as an output pipe (queue) for a neural network processing operation. Thus a given neural network processing operation will in an embodiment have one or more pipes in the local storage defined as its inputs, and one or more, and in an embodiment a single, pipe in the local storage defined as its output.

The width and height of a “pipe” (FIFO queue) are definable/settable (programmable), as is the number of buffers (entries) in the pipe. This allows it to be selectively defined and indicated as to whether a given pipe should be, for example, double buffered, or higher/lower buffered, e.g. to compensate for latency (such as memory access latency, or pipeline latency where several operations are performed before buffers are needed again).

In the case where, as discussed above, an overall neural network processing “job” is subdivided into plural individual blocks of work for processing purposes, then each block of work will have its own respective entry or entries (buffer or buffers) in a given pipe (FIFO queue) in the local storage of the neural processor.

The buffers of a given pipe (FIFO queue) are (in an embodiment directly) related to the blocks of work (the block iteration) that is used for the neural network processing, discussed above. Each block has a one-to-one mapping with a buffer in a respective pipe (FIFO queue) in the local storage for the sequence of neural network processing that the block in question is to undergo. In this regard, a block execution might use multiple inputs, in which case it will, and in an embodiment does, consume multiple buffers in the local storage, each from separate pipes. Correspondingly, a block may output a single buffer into its destination pipe in the local storage.

(Thus, as shown in FIG. 5, the indications of neural network processing to be performed that are provided to the control unit of the neural processor include appropriate indications of the number and configuration of “pipes” that should be provided and used in the local storage of the neural processor when performing the neural network processing in question.)

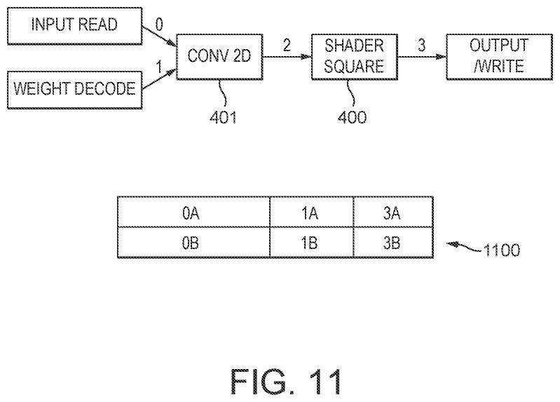

FIG. 11 shows an exemplary shared buffer 1100 layout for the sequence of operations to be performed in FIG. 5. In this regard, for the pipes stored in the shared buffer, the number reference indicates the pipe that it relates to and the letter indicates the buffer (so 3B is the second buffer in the third pipe). One FIFO queue entry is one buffer, and in the arrangements shown in FIG. 11 all the pipes are double buffered (have two queue entries), but single or more buffering is possible. As shown in FIG. 11, not all pipes are necessarily stored in the shared buffer 1100.

As shown in FIG. 5, the neural engine descriptor 510 also indicates 502 where in memory the input data for the sequence of operations defined by the descriptor 510 is found, and where in memory the output data for the sequence of operations defined by the descriptor 510 should be stored.

The descriptor 510 also defines a “block size” 504 which sets out the size of block that the overall operation (iteration) space that the neural network is to be executed for should be subdivided into for the purposes of distributing to the execution units of the neural engine 202 or to the shader execution core 201 when performing the neural network processing.

In this regard, the command to the control unit (TSU) 217 for the neural engine 202 will indicate an overall operation (iteration) space for which the neural network processing is to be performed. The TSU 217 will then divide that overall iteration operation space into a sequence of smaller blocks of that space (as defined by the neural engine descriptor), and then send those blocks in turn (in a pipelined fashion) to the execution units of the neural engine 202 and/or to the shader execution core 201, for processing.

The TSU 217 will also, although it divides the overall operation space into blocks in that common, initial, overall operation space, when distributing a block to an execution unit or to the shader execution core 201, transform the block from the, e.g. multidimensional, initial, common operation space, to the required dimensions of the space that the execution unit or shader execution core operates in. Thus, in the case of sending a block for shader execution, the TSU 217 will transform the block from whatever multidimensional operation space it is initially defined with respect to, to the three-dimensional thread coordinate ID space that the shader execution core operates in.

As discussed above, the neural engine descriptor 510 for the higher level neural network shown in FIG. 4 will be generated by an appropriate compilation process.

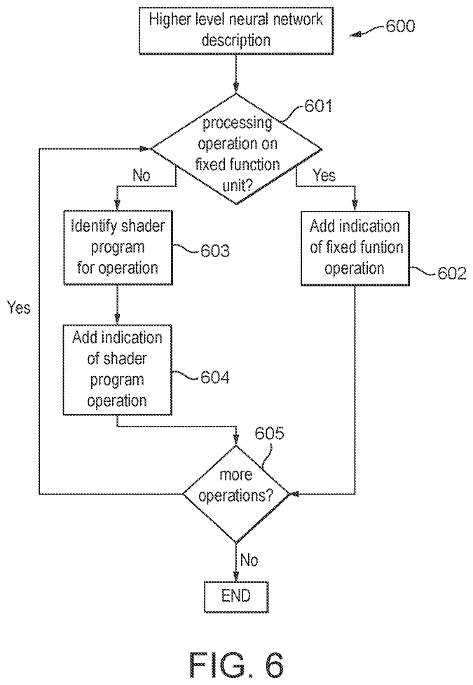

FIG. 6 illustrates this, and shows that the compilation process will receive the higher level neural network description (e.g. in a graph form) (step 600), consider each processing operation for the higher level neural network in turn, and determine whether the processing operation can be performed by a fixed function execution unit of the neural engine 202 or not (step 601).

In the case where the processing operation can be performed by a fixed function execution unit of the neural engine 202, then an indication of the operation and that it should be performed by a fixed function execution unit of the neural engine 202 will be added to the neural engine descriptor (step 602), but in the case where the operation is not supported by a fixed function execution unit of the neural engine 202, instead an appropriate shader program for performing the processing operation will be identified (step 603), and an indication that a shader program execution should be performed for that processing operation (and of the shader program to be executed) is added to the neural engine descriptor (step 604).

This is repeated for each operation required for the higher level neural network (step 605).

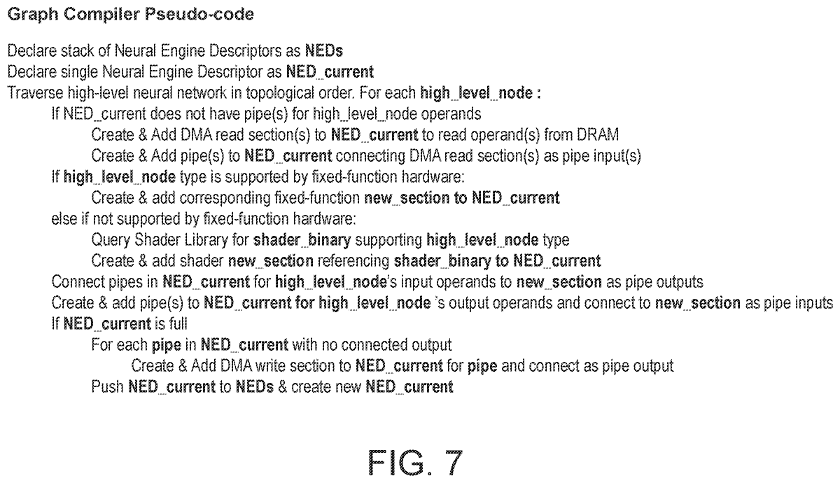

FIG. 7 shows in more detail exemplary graph compiler pseudo-code for this operation, that shows, in particular, the generation of appropriate sections and pipes for a neural engine descriptor based on a high level neural network description.

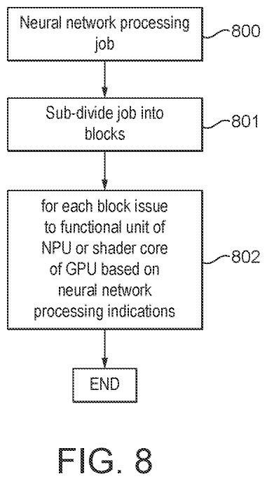

FIG. 8 shows the operation when the control unit (TSU) 217 of the neural engine is triggering and controlling the performance of neural network processing operations based on an indication of those operations, such as the NED 510 shown in FIG. 5, to perform neural network processing.

Thus, as shown in FIG. 8, the TSU 217 will first read the appropriate neural network processing indications (NED) from memory (step 800), and subdivide the overall despatch processing task from the command stream frontend 220 into respective fixed size blocks of the operation space (as indicated by the block size in the NED) (step 801). The TSU 217 will then iterate through the fixed size blocks, issuing them to functional units as indicated by the “sections” 500 in the NED (step 802). Each such block will effectively be issued to the appropriate functional units in turn, in a pipelined fashion, in accordance with the operations (sections) 500 indicated in the NED. The TSU also tracks and manages any dependencies.

When issuing a block to a functional unit, the TSU 217 applies a transform from the, e.g. 8D TSU operation space, to the functional unit's operation space (which will usually have fewer dimensions). For example, shader program execution sections will have three dimensions.

When a block is to undergo a processing operation, it is issued to the respective execution unit of the neural engine 202, or to the shader despatch unit 218 (for shader program execution), as appropriate, as indicated by the operations (sections) in the neural engine descriptor 510.

Thus, for example, for the exemplary neural engine descriptor 510 shown in FIG. 5, a (and each) block that the overall operation space is divided into will be issued first to the neural engine DMA unit 215 for the input data and weights to be read and loaded into the appropriate buffers (pipes) in the shared buffer 210.

Once the DMA reads have been completed, the block will then be issued to the fixed function convolution unit 213 of the neural engine 202 for the fixed function convolution operation to be performed.

Once that has been completed, the block will be issued to the shader despatch unit 218 for execution of the shader program to perform the elementwise square operation.

Finally, once the shader program execution has been completed, the block will be sent to the neural engine DMA unit 215 to write the output of the elementwise square operation to memory.

The despatching of blocks for processing operations by execution units of the neural engine 202 may proceed in the normal manner for the neural engine in question.

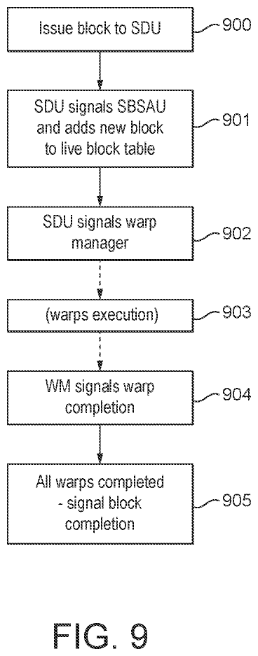

In the case of processing operations (sections) that are performed by means of shader program execution by the shader execution core, the operation proceeds as indicated in FIG. 9.

As shown in FIG. 9, when a block is to undergo shader program execution, the TSU 217 despatches the block to the shader despatch unit 218 (step 900). In particular, the TSU issues the SDU blocks of works to process using the SDU's native coordinate system (in this case a 3D thread ID space). To do this, in the present embodiments, the TSU sends a message of the following form to the SDU 218:

```
      TSU-SDU: block issue message:
      uint tsu_block_id TSU's ID of the block being issued
      uint[3] block_start_coord The thread-space coordinates of the first
element of the block being issued
      uint[3] block_size The size of the block in thread-space
      ptr shader_program_descriptor Pointer to the location in memory
where the shader program descriptor can be found, it contains E.g. address of first
instruction
      ptr shader_resource_table Pointer to the NED's resource table, which the
shader uses as a shader resource table in case it needs things like texture
resoruces
      uint reg_preload_base_offset When register pre-load/post-store is being
used, data will start to be copied to this numbered register and above
      uint[4] reg_preload_block_xform Controls which elements from the 4D
buffer get loaded into which thread ID's register file
      buffer_info[4] input_sbuffer_info Information describing each of the 4
input buffers within the shared buffer. Info contains things like the buffer's offset,
strides, layout, etc.
      buffer_info[2] output_sbuffer_info Information describing each of the 2
output buffers within the shared buffer. Info contains things like the buffer's offset,
strides, layout, etc.
```

Upon receipt of a block of work from the TSU 217, the shader despatch unit 218 signals the shared buffer shader access unit (SBSAU) 209 of the neural engine with the relevant information for the new block's input and output buffers (step 901).

The Shared Buffer Shader Access Unit 209 facilitates access from the Shader Execution Core to the Shared Buffer Unit. It principally holds a table allowing SB addresses to be calculated from state held by the shader execution core. There's an entry in the table per live shader block, each entry containing the buffer info for each input and output buffer. The buffer info contains everything needed to calculate the shared buffer address from the 4D cords passed to it and contains things like the base address, strides and layout.

The SDU 218 sends a message of the following form to the SBSAU 209 to add an entry in its table of live blocks:

```
      SDU-SBSAU: Add table entry
      uint tsu_block_id The tsu block id of the new entry
      buffer_info[4] input_sbuffer_info Information describing each of the 4
input buffers within the shared buffer. Info contains things like the buffer's offset,
strides, layout, etc.
      buffer_info[2] output_sbuffer_info Information describing each of the 2
output buffers within the shared buffer. Info contains things like the buffer's offset,
strides, layout, etc.
```

In response to this the SBSAU 209 finds a free slot in its live blocks table (or waits until a free slot is available) and populates it with the input/output buffer information for the block in question, referenced by the TSU block ID of the new entry.

The shader dispatch unit 218 also adds the new block of work to a table of “live” blocks that it maintains (to track the processing of blocks) (or waits until there is a free entry in the table for a new block) (step 901). For each “live” block, the shader dispatch unit also maintains a “live” warps (thread groups) table so that it can track the progress of thread groups (warps) for the block in question.

The shader despatch unit 218 then signals the warp manager 204 of the shader execution core 201 to cause a sequence of thread groups (warps) corresponding to the iteration space of the block in thread-space to be generated (step 902). Thus, the Shader Dispatch Unit takes a block of shader work and dispatches it to the Shader Execution Core via its Warp Manager.

In the present embodiments, for each warp (e.g. of 16 threads in the case where the execution engine supports 16 thread wide thread groups (warps)), of the block in thread space, an appropriate message is sent to the warp manager 204 to spawn such a warp and execute the desired shader program for the warp by the execution engine 203.

To do this, in the present embodiments, for each thread group (warp) to be issued to execute the shader program to perform the neural network processing operation for the block in question, a warp issue message of the following form is sent from the shader despatch unit 218 to the warp manager 204:

```
      SDU-WM: Warp issue message
      uint tsu_block_id The tsu block ID the warp is being issued for. This is
added to the per-warp state vector and provides the context for accesses into the
NE's shared buffer through the SBSAU
      ptr srt The pointer to the NED's shader resource table which shader
instructions might use for things like texture sampling
      ptr shader_program The pointer to the shader program descriptor, which
contains state needed for a shader program execution, such as the address of the
shader's first instruction, etc.
      uint[3] warp_offset The coordinates in thread-space of the first thread in
the warp
      uint thread_mask A bitmask indicating which threads in the warp should
be run, principally used when there's fewer threads needed than the fixed warp-size
```

In addition to this, the thread group (warp) is added to the “live” warps table maintained by the shader despatch unit for the block (that is used to track “live” warps for which issue messages have been sent and that are performing neural network processing for the block in question). (If the table of live warps is full when a new warp is to be issued, then the shader despatch unit will wait for a warp to complete and then add a new entry to the live warps table and then issue the warp to the warp manager.)

In response to a warp issue message from the shader despatch unit 218, the warp manager 204 will issue a warp to the execution engine 203 to execute the shader program indicated in the warp issue message (step 903). This can be and is done in the normal manner for program execution in the graphics processor in question.

Once a warp has completed its shader program execution, the warp manager 204 returns a warp completion message of the following form to the shader despatch unit 218 (step 904):

```
      WM-SDU: Warp completion message
      uint tsu_block_id The tsu block id of the warp
      which has completed
      uint[3] warp_offset Which warp has completed,
identified by its first thread's thread-space coordinates
```

In response to the warp completion message, the shader despatch unit 218 will find the entry in its live blocks table for the block in question, and find and remove the warp in the corresponding live warps table for that block.

Once all the warps for a given block of work have completed their execution (i.e. the live warps table for the block in question is empty), the shader despatch unit 218 sends a message to the TSU indicating that the shader program execution for the block has been completed (step 905):

```
      SDU-TSU: Block completion message
      uint tsu_block_id The ID of the block which has
completed and removes the block from its “live” blocks table.
```

In this way, the performing of shader program execution for blocks of work can be, and is, appropriately tracked.

The shader dispatch unit 218 also sends a message to the shared buffer shader access unit 209 of the following form indicating that the shader processing for the block in question has been completed, so that the entry for the block maintained by the shared buffer shader access unit 209 can be removed:

```
      SDU-SBSAU: Drop table entry
      uint tsu_block_id The tsu block id of the entry which
should be dropped
```

In response to this message, the SBSAU 209 will find and remove the entry in its live blocks table corresponding to the block in question.

As will be appreciated from, for example, the exemplary neural network processing illustrated in FIG. 5, in that neural network processing, the elementwise square operation 400 that is performed by means of shader program execution in the shader execution core 201 will take as its input the output from the fixed function convolution operation 401 and will also need to return its output to the neural engine 202 so that it can then be written out to memory by means of the following DMA write operation. Thus there will need to be a mechanism for transferring data between the shader execution core 201 and the neural engine 202 for this purpose.

In the present embodiments, the system is configured, as shown in FIG. 2, such that data can be directly transferred between the local storage, register file 205 of the shader execution core 201 and the local storage, shared buffer 210 of the neural engine 202 (rather than having to transfer data via the L1 cache 207 and the memory system, for example).

In a first embodiment, such transfer of data directly between the register file 205 and the shared buffer 210 of the neural engine 202 is achieved by means of the register preload unit (RPU) 211. In particular, the Register Pre-Load unit can operate to load data directly into the register file 205 before a shader program begins to execute (for a warp, e.g.) and to copy (write) data back out of the register file after a warp has retired.

To facilitate this operation, the warp manager 204 is operable to issue register “pre-loads” through the RPU before issuing a warp for execution, and to issue register “post-stores” through the RPU after a warp has completed.

To issue a register “pre-load”, the warp manager sends a pre-load message of the following form to the RPU:

```
      WM-RPU Pre-load registers from NE SB
      uint tsu_block_id TSU's ID of the block for which a preload
needs to take place
      uint warp_id Which warp's portion of the register file needs to be
pre-loaded
      uint[4] reg_base_offset Which numbered register should each
input buffer begin to be pre-loaded into. Preloads may span multiple registers.
      uint[4] reg_count For each of the 4 input buffers, how many
registers should be pre-loaded
      xform[4] tid_to_buffer_xform Controls how registers for thread ids within the
warp being pre-loaded map to the 4D buffer coordinates to load (e.g. xform could
be a 4x4 matrix mapping [ThreadID.x, ThreadID.y, ThreadID.z, register#] to 4D
buffer coordinates).
```

In response to such a pre-load request from the warp manager 204, the register pre-load unit 211 calculates the register file location for each thread in indicated warp, and then for each input buffer, for each register to be pre-loaded, uses the indicated “xform” mapping to calculate the buffer coordinates to load for the register in question.

The register pre-load unit 211 then issues a read to the SBSAU 209 for the input buffer at the calculated buffer coordinates, as follows:

```
      RPU-SBSAU Load value from shared buffer (value is returned in the
response)
      uint tsu_block_id TSU's ID of the block for which the load is
being issued. This comes from warp manager state. The SBSAU uses this as a key
into it's table of live shader blocks
      uint input_id Which of the 4 input buffers is being accessed
      uint[4] buffer_coords The 4D coordinates of the element within the
buffer being loaded
```

In response to this load value request, the SBSAU 209 finds the entry in its live blocks table for the indicated block and determines the relevant buffer_info for the indicated input buffer from that live blocks table entry. It then calculates the address in the shared buffer 210 to be read from the indicated 4D buffer coordinates and corresponding buffer_info, and issues a read for the calculated shared buffer address to the shared buffer unit 216.

The read data from the shared buffer is then returned to the SBSAU 209 in response, and the SBSAU 209 returns that data to the register pre-load unit 211, which then writes the data to the corresponding register in the register file 205.

Correspondingly, to issue a register “post-store”, the warp manager sends a post-store message of the following form to the RPU:

```
WM-RPU Post-store registers to NE SB
      uint tsu_block_id TSU's ID of the block for which a post-store
needs to take place
      uint warp_id Which warp's portion of the register file needs to be
post-stored
      uint[2] reg_base_offset For each of the output buffers, which is
the first numbered register where values needing to be stored is held. Post-stores
may span multiple registers.
      uint[2] reg_count For each of the 2 output buffers, how many
registers should be post-stored
      xform[4] tid_to_buffer_xform Controls how registers for thread ids within the
warp being post-stored map to the 4D buffer coordinates to store to (e.g. xform
could be a 4x4 matrix mapping [ThreadID.x, ThreadID.y, ThreadID.z, register#] to
4D buffer coordinates).
```

In response to such a post-store request from the warp manager 204, the register pre-load unit 211 calculates the register file location for each thread in the indicated warp, and then for each output buffer, for each register to be post-stored, uses the indicated “xform” mapping to calculate the buffer coordinates to store the register in question to.

The register pre-load unit 211 then issues a store to the SBSAU 209 for the output buffer at the calculated buffer coordinates, using the value from the register file, as follows:

```
      RPU-SBSAU Store value to shared buffer
      uint tsu_block_id TSU's ID of the block for which the load is
being issued. This comes from warp manager state. The SBSAU uses this as a key
into its table of live shader blocks
      uint output_id Which of the 2 output buffers is being accessed
      uint[4] buffer_coords The 4D coordinates of the element within the
buffer being stored
      uint value The (bit pattern of the) value being stored into the
shared buffer
```

In response to this store value request, the SBSAU 209 finds the entry in its live blocks table for the indicated block and determines the relevant buffer_info for the indicated output buffer from that live blocks table entry. It then calculates the address in the shared buffer 210 where the data (value) is to be stored from the indicated 4D buffer coordinates and corresponding buffer_info, and issues a store for the calculated shared buffer address to the shared buffer unit 216 passing the indicated data (value). The data (value) is then written to the indicated address in the shared buffer.

In this operation, the relevant values for the shader program execution will be pre-loaded from the shared buffer 210 of the neural engine before program execution for a thread group (warp) is begun, and, correspondingly, written back (post-stored) to the shared buffer once the thread group (warp) has completed execution of the shader program. Thus an exemplary shader program for performing the element-wise square operation when using such “pre-load” and “post-store” operations may be as follows:

; assume r0-r3 are pre-loaded from correct portion of input0
MUL r4, r0, r0 ; Compute square of 1st element into r4
MOV r0, r4 ; Copy into r0 (output for 1st element)
MUL r4, r1, r1 ; Compute square of 2nd element into r4
MOV r1, r4 ; Copy into r1 (output for 2nd element)
MUL r4, r2, r2 ; Compute square of 3rd element into r4
MOV r2, r4 ; Copy into r2 (output for 3rd element)
MUL r4, r3, r3 ; Compute square of 4th element into r4
MOV r3, r4 ; Copy into r3 (output for 3rd element)
TERM ; Thread complete, terminate
; assume r0-r3 are post-stored to correction portion of output0

In another embodiment, the transfer of data directly between the register file 205 and the shared buffer 210 of the neural engine 202 is achieved by including respective load and store instructions that when executed cause such data transfer in the shader program that is executed to perform the neural network processing operations. This may be used as well as or instead of the “pre-load” and “post-store” operations discussed above.

In this case, a shader program to be executed can include a special type of load instruction (“LOADSB”) that will trigger a load from the shared buffer 210 to a register or registers of the register file 205 when executed, and a special type of store instruction (“STORESB”) that will trigger the copying of data (a value or values) from a register or registers of the register file 205 to the shared buffer 210 of the neural engine 202.

In this case therefore, a shader program to perform the above elementwise square operation may be of the form:

```
(assume tid_[xyz] are special registers holding 3D thread id)
MOV r7, #4 ; Initialize loop counter for 4 iterations
MUL r6, tid_x, #4 ; Calculate base x-coord for buffer load/store
top:
SUB r7, #1 ; Decrement loop counter
ADD r0, r7, r6 ; Calculate buffer x-coord for this iteration
LOADSB r1, #0, #0, #0, r0, tid_y ; Load r1 from NE shared buffer
            ; input0, buffer element [0,0, r0, tid_y]
MUL r2, r1, r1 ; Compute square
STORESB r2, #0, #0, #0, r0, tid_y ; Store r2 into NE shared buffer
            ; output0, buffer element [0, 0, r0, tid_y]
CBNZ r7, top ; Repeat if this was not the last iteration
TERM ; Thread complete, terminate
```

In this case, the Load/Store Unit 206 of the shader execution core 201 is configured to implement the LOADSB/STORESB instructions. These instructions are implemented by taking instruction operands together with tsu_block_id from the warp state vector and issuing load or store requests into the SBSAU 209 (directly from the load/store unit 206). Thus the Load/Store Unit 206 implements LOADSB/STORESB instructions, which copy data between the register file and NE's Shared Buffer.

Thus, in response to the execution of a LOADSB instruction, the load/store unit 206 issues a read to the SBSAU 209, as follows:

```
      LSU-SBSAU Load value from shared buffer (value is returned in the
response)
      uint tsu_block_id TSU's ID of the block for which the load is
being issued. This comes from warp manager state. The SBSAU uses this as a key
into it's table of live shader blocks
      uint input_id Which of the 4 input buffers is being accessed
      uint[4] buffer_coords The 4D coordinates of the element within the
buffer being loaded
```

In response to this load value request, the SBSAU 209 finds the entry in its live blocks table for the indicated block and determines the relevant buffer_info for the indicated input buffer from that live blocks table entry. It then calculates the address in the shared buffer 210 to be read from the indicated 4D buffer coordinates and corresponding buffer_info, and issues a read for the calculated shared buffer address to the shared buffer unit 216.

The read data from the shared buffer is then returned to the SBSAU 209 in response, and the SBSAU 209 returns that data to the load/store unit 206, which then writes the data to the corresponding register in the register file 205.

Correspondingly, in response to the execution of a STORESB instruction, the load/store unit 206 issues a store to the SBSAU 209, using the value from the register file, as follows:

```
      LSU-SBSAU Store value to shared buffer
      uint tsu_block_id TSU's ID of the block for which the load is
being issued. This comes from warp manager state. The SBSAU uses this as a key
into its table of live shader blocks
      uint output_id Which of the 2 output buffers is being accessed
      uint[4] buffer_coords The 4D coordinates of the element within the
buffer being stored
      uint value The (bit pattern of the) value being stored into the
shared buffer
```

In response to this store value request, the SBSAU 209 finds the entry in its live blocks table for the indicated block and determines the relevant buffer_info for the indicated output buffer from that live blocks table entry. It then calculates the address in the shared buffer 210 where the data (value) is to be stored from the indicated 4D buffer coordinates and corresponding buffer_info, and issues a store for the calculated shared buffer address to the shared buffer unit 216 passing the indicated data (value). The data (value) is then written to the indicated address in the shared buffer.

It will be appreciated that when using such LOADSB and STORESB instructions, they will need to be included at appropriate points in the shader program that is to be executed to perform the processing operations for the neural network processing. This is in an embodiment done when, and as part of, the compilation process for the shader program.

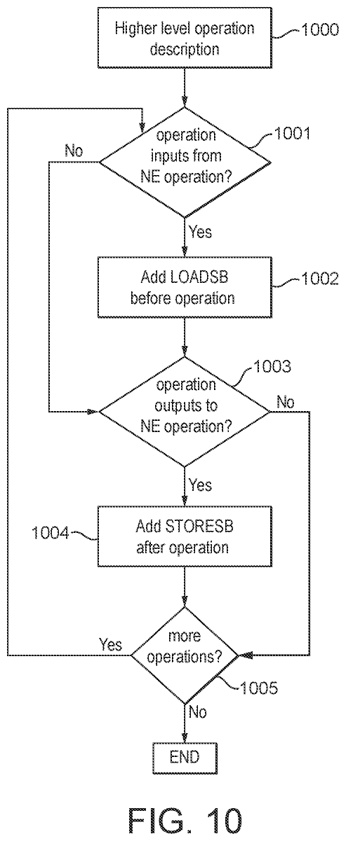

FIG. 10 shows an embodiment of a suitable such compilation process.

As shown in FIG. 10, the compilation process will take a higher level of description of the operations to be performed by the shader program (step 1000) and, for each operation, consider whether the operation will use inputs that will be stored in the shared buffer of the neural engine (step 1001). If so, a LOADSB instruction will be added to the shader code before the instruction(s) for performing the operation itself (step 1002).

It will then be considered whether the output from the operation will be needed for an operation to be performed by the neural engine (step 1003). If so, a STORESB instruction is added to the shader code after the instruction(s) for performing the operation (step 1004).

This is repeated for each operation to be performed by the shader program (step 1005).

The present embodiments may provide various benefits and improvements compared to other possible approaches.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated.

What is claimed is:

1. A method of operating a data processing system, the data processing system comprising:
a processor that is configured to perform neural network processing, the processor comprising:
one or more execution units configured to perform processing operations for neural network processing; and
a control circuit configured to distribute processing tasks to the execution unit or units to cause the execution units to perform processing operations for neural network processing in response to indications of neural network processing to be performed provided to the control circuit;
the data processing system further comprising a graphics processor, the graphics processor comprising a programmable execution unit operable to execute processing programs to perform processing operations;
the method comprising:
the control circuit of the processor that is configured to perform neural network processing, in response to an indication of neural network processing to be performed, causing the programmable execution unit of the graphics processor to execute a program to perform the indicated neural network processing.

2. The method of claim 1, comprising the control circuit of the processor that is configured to perform neural network processing that is configured to distribute processing tasks to the execution unit or units of the neural processor to cause the execution units to perform processing operations for neural network processing:
subdividing an overall neural network processing task to be performed into a plurality of smaller blocks of neural network processing; and
causing the execution unit(s) to execute the neural network processing operations for the blocks individually.

3. The method of claim 1, wherein
the indications of the neural network processing to be performed are in the form of one or more sets of neural network processing information, with each such set of information indicating a sequence of one or more processing operations to be performed for the neural network processing, an indication of data inputs and outputs for operation(s) in the sequence indicated by the set of information, and an indication of the location in memory of the initial input to the sequence of operations and/or of where the output from the sequence of operations should be stored.

4. The method of claim 1, wherein the indications of neural network processing to be performed that are provided to the control circuit of the processor configured to perform neural network processing can indicate that a neural network processing operation should be performed by the programmable execution unit of the graphics processor executing a program to perform that neural network processing operation; and
the method comprises:
the control circuit of the processor that is configured to perform neural network processing in response to an indication of a neural network processing operation(s) to be performed by execution of a program by the programmable execution unit of the graphics processor, causing the programmable execution unit of the graphics processor to execute a program to perform the neural network processing operation(s).

5. The method of claim 1, wherein the graphics processor comprises a control circuit operable to control the execution of programs to perform processing operations by the execution unit of the graphics processor, and the control circuit of the processor configured to perform neural network processing causes the programmable execution unit of the graphics processor to execute a program to perform a processing operation(s) for neural network processing by communicating with the control circuit of the graphics processor, to thereby cause the program execution to be performed.

6. The method of claim 1, wherein:
the processor configured to perform neural network processing comprises local storage that is used for storing data locally while an execution unit or units of the processor are performing neural network processing; and
the graphics processor comprises local storage for storing data for use by the programmable execution unit of the graphics processor when executing a program;
and the method comprises:
when the programmable execution unit of the graphics processor is to execute or is executing a program to perform a processing operation for neural network processing under the control of the control circuit of the processor configured to perform neural network processing:
loading data directly from the local storage of the processor configured to perform neural network processing to local storage of the graphics processor for use when the programmable execution unit of the graphics processor is executing the program to perform a processing operation for neural network processing; and/or
storing data generated by the execution of a program by the programmable execution unit of the graphics processor to perform a processing operation(s) for neural network processing directly from the local storage of the graphics processor to the local storage of the processor configured to perform neural network processing.

7. The method of claim 6, comprising at least one of:
loading data from the local storage of the processor configured to perform neural network processing to the local storage for the programmable execution unit of the graphics processor before execution of a program to perform an operation or operations for neural network processing is begun; and
writing data from the local storage for the programmable execution unit of the graphics processor that has executed the program to perform the processing operation(s) for the neural network processing to the local storage of the processor configured to perform neural network processing after execution of a program to perform an operation or operations for neural network processing has been completed.

8. The method of claim 1, wherein:
the processor configured to perform neural network processing comprises local storage that is used for storing data locally while an execution unit or units of the processor is performing neural network processing; and
the graphics processor comprises local storage for storing data for use by the programmable execution unit of the graphics processor when executing a program;
and the method comprises at least one of:
when the programmable execution unit of the graphics processor is executing a program to perform a processing operation for performing neural network processing, the programmable execution unit in response to an instruction in the program being executed, causing data to be loaded from the local storage of the processor that is configured to perform neural network processing to local storage for the programmable execution unit for use when executing the program to perform the processing operation(s) for neural network processing; and
when the programmable execution unit of the graphics processor is executing a program to perform a processing operation for performing neural network processing, the programmable execution unit in response to an instruction in the program being executed, causing data to be written from the local storage for the programmable execution unit into the local storage of the processor that is configured to perform neural network processing.

9. A data processing system, the data processing system comprising:
a processor that is configured to perform neural network processing, the processor comprising:
one or more execution units configured to perform processing operations for neural network processing; and
a control circuit configured to distribute processing tasks to the execution unit or units to cause the execution units to perform processing operations for neural network processing in response to indications of neural network processing to be performed provided to the control circuit;
the data processing system further comprising a graphics processor, the graphics processor comprising a programmable execution unit operable to execute processing programs to perform processing operations;
wherein:
the control circuit of the processor that is configured to perform neural network processing is configured to:
in response to an indication of particular neural network processing to be performed, cause the programmable execution unit of the graphics processor to execute a program to perform the indicated neural network processing.

10. The system of claim 9, wherein the control circuit of the processor that is configured to perform neural network processing that is configured to distribute processing tasks to the execution unit or units of the neural processor to cause the execution units to perform processing operations for neural network processing is configured to:
subdivide an overall neural network processing task to be performed into a plurality of smaller blocks of neural network processing; and
cause the execution unit(s) to execute the neural network processing operations for the blocks individually.

11. The system of claim 9, wherein the indications of neural network processing to be performed that are provided to the control circuit of the processor configured to perform neural network processing can indicate that a neural network processing operation should be performed by the programmable execution unit of the graphics processor executing a program to perform that neural network processing operation; and
the control circuit of the processor that is configured to perform neural network processing is configured to, in response to an indication of a neural network processing operation(s) to be performed by execution of a program by the programmable execution unit of the graphics processor, cause the programmable execution unit of the graphics processor to execute a program to perform the neural network processing operation(s).

12. The system of claim 9, wherein the graphics processor comprises a control circuit operable to control the execution of programs to perform processing operations by the execution unit of the graphics processor; and
the control circuit of the processor configured to perform neural network processing is configured to cause the programmable execution unit of the graphics processor to execute a program to perform a processing operation(s) for neural network processing by communicating with the control circuit of the graphics processor, to thereby cause the program execution to be performed.

13. The system of claim 9, wherein:
the processor configured to perform neural network processing comprises local storage for storing data locally while an execution unit or units of the processor are performing neural network processing; and
the graphics processor comprises local storage for storing data for use by the programmable execution unit of the graphics processor when executing a program;
and the graphics processor comprises:
a local storage pre-load/post-store circuit that is configured to transfer data directly between the local storage of the processor configured to perform neural network processing and the local storage of the graphics processor.

14. The system of claim 9, wherein:
the processor configured to perform neural network processing comprises local storage for storing data locally while an execution unit or units of the processor is performing neural network processing; and
the graphics processor comprises local storage for storing data for use by the programmable execution unit of the graphics processor when executing a program; and
the programmable execution unit of the graphics processor is configured to, in response to an instruction in a program being executed by the programmable execution unit that indicates that data should be loaded from local storage of a processor configured to perform neural network processing to local storage for the programmable execution unit, cause data to be loaded from local storage of the processor configured to perform neural network processing to the local storage for the programmable execution unit; and/or
the programmable execution unit of the graphics processor is configured to, in response to an instruction in a program being executed by the programmable execution unit that indicates that data should be stored into local storage of a processor configured to perform neural network processing from local storage for the programmable execution unit, cause data to be stored into local storage for the processor configured to perform neural network processing from the local storage of the programmable execution unit.

15. The system of any one of claim 9, wherein:
the processor configured to perform neural network processing comprises local storage for storing data locally while an execution unit or units of the processor is performing neural network processing; and
the graphics processor comprises local storage for storing data for use by the programmable execution unit of the graphics processor when executing a program; and
the graphics processor further comprises a load/store circuit having:
an interface to a memory system of the data processing system, whereby it may transfer data between the local storage for the programmable execution unit of the graphics processor and the memory system of the data processing system; and
a separate interface with the processor that is configured to perform the neural network processing, whereby it may transfer data between the local storage of the processor that is configured to perform neural network processing and the local storage for the programmable execution unit of the graphics processor.

16. The system of claim 9, wherein:
the graphics processor comprises an execution core, and the processor that is configured to perform neural network processing comprises a neural processor that is associated with and coupled to the execution core; and
the execution core and neural processor share a cache of a memory system hierarchy of the data processing system, via which they are operable to read data from, and write data to, memory of the data processing system.

17. The system of claim 9, further comprising:
a control unit operable to receive indications of processing tasks to be performed from a processor, and configured to, in response to such indications distribute processing tasks either to the control circuit of the processor configured to perform neural network processing or to a control circuit of the graphics processor.

18. A graphics processor, the graphics processor comprising:
a programmable execution unit operable to execute processing programs to perform processing operations; and
local storage configured to store data for use by the programmable execution unit of the graphics processor when executing a program;
wherein:
the programmable execution unit is configured to:
in response to an instruction in a program being executed by the programmable execution unit, cause data to be loaded from local storage of a processor configured to perform neural network processing to the local storage of the graphics processor for use by the programmable execution unit of the graphics processor when executing further instructions in the program being executed; and/or
in response to an instruction in a program being executed by the programmable execution unit, cause data stored in the local storage for the programmable execution unit of the graphics processor during execution of the program by the programmable execution unit of the graphics processor to be written to local storage of a processor configured to perform neural network processing.

19. A non-transitory computer program comprising computer software code for performing the method of claim 1 when the program is run on one or more data processors.
